(19) United States
(12) Patent Application Publication
(10) Pub. No.: US 2026/0222018 A1
(43) Pub. Date: Jul. 30, 2026

(54) INTERFERENCE-MITIGATING CODE BLOCK MAPPING ACROSS MORE THAN TWO LAYERS OF A MULTIPLE-INPUT, MULTIPLE-OUTPUT TRANSMISSION USING SPATIALLY-COUPLED MULTIPLE-INPUT, MULTIPLE-OUTPUT

(71) Applicant: QUALCOMM Incorporated, San Diego, CA (US)

(72) Inventors: Kirill IVANOV, La Jolla, CA (US); Wei YANG, San Diego, CA (US)

(21) Appl. No.: 19/041,799

(22) Filed: Jan. 30, 2025

(51) Int. Cl. H04B 7/0413; H04L 5/00

(52) U.S. Cl. CPC H04B 7/0413; H04L 5/0005

(57) ABSTRACT

Various aspects of the present disclosure generally relate to wireless communication. In some aspects, a transmitter may map two or more code blocks across N layers of a multiple-input, multiple-output (MIMO) transmission by separating each code block into N code block partitions and assigning each layer a respective code block partition, N being an integer greater than two. The mapping of the code blocks may be based at least in part on a spatially-coupled MIMO-based mapping scheme. The transmitter may map two or more interference-mitigating code blocks across the N layers by separating each interference-mitigating code block into N interference-mitigating code block partitions and assigning each layer a respective interference-mitigating code block partition. Mapping the interference-mitigating code blocks may be complementary to the mapping of the code blocks. The transmitter may transmit the MIMO transmission based at least in part on the mapping. Numerous other aspects are described.

### FIELD OF THE DISCLOSURE

Aspects of the present disclosure generally relate to wireless communication and specifically relate to techniques, apparatuses, and methods associated with interference-mitigating code block mapping across more than two layers of a multiple-input, multiple-output (MIMO) transmission using spatially-coupled MIMO.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A transmitter may use spatially-coupled multiple-input, multiple-output (SC-MIMO) to improve a robustness, reliability, and/or data throughput for a MIMO transmission in scenarios where there is significant variation in channel conditions across the MIMO layers. More particularly, SC-MIMO may use a mapping scheme that increases a coupling between MIMO layers using a structured dependency between the layers such that a MIMO layer may be decoded using at least some information from another MIMO layer, resulting in increased robustness, reliability, and/or data throughput. To illustrate, a single codeword may be partitioned into multiple independent code blocks, and each independent code block may be partitioned into multiple code block partitions. To increase a coupling between MIMO layers, an SC-MIMO code block mapping scheme may use a structured dependency that maps a first code block partition of a first independent code block to a first layer and a second code block partition of a second independent code block to a second layer such that the first code block partition is transmitted simultaneously with the second code block partition via different layers. A receiver may use successive interference cancellation (SIC) to subtract the first code block partition from the second code block partition (or vice versa) to improve data recovery for the remaining signal as described below.

### SUMMARY

Some aspects described herein relate to a method of wireless communication performed by a transmitter. The method may include mapping two or more code blocks across N layers of a multiple-input, multiple-output (MIMO) transmission, each code block of the two or more code blocks being separated into N code block partitions such that each layer of the N layers is assigned a respective code block partition of the N code block partitions, the mapping of the two or more code blocks being based at least in part on a spatially-coupled multiple-input, multiple-output (SC-MIMO) mapping scheme and N being an integer greater than two. The method may include mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks. The method may include transmitting the MIMO transmission based at least in part on the mapping of the two or more code blocks and the mapping of the two or more interference-mitigating code blocks.

Some aspects described herein relate to a method of wireless communication performed by a receiver. The method may include receiving a MIMO transmission that includes N layers, N being an integer that is greater than two, the MIMO transmission including two or more code blocks and two or more interference-mitigating code blocks. The method may include decoding the MIMO transmission based at least in part on, a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Some aspects described herein relate to a method of wireless communication performed by a transmitter. The method may include mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being a first integer greater than two, the N layers being separated into L layer groups of equal size, L being a second integer. The method may include mapping an interference-mitigating code block across a first set of (L−1) layer groups based at least in part on the interference-mitigating code block being separated into N interference-mitigating code block partitions. The method may include mapping a tail code block across a second set of (L−1) layer groups based at least in part on the tail code block being separated into N tail code block partitions, the mapping of the tail code block being complementary to the mapping of the interference-mitigating code block. The method may include transmitting the MIMO transmission based at least in part on the mapping of the two or more code blocks, the mapping of the interference-mitigating code block, and the mapping of the tail code block.

Some aspects described herein relate to a method of wireless communication performed by a receiver. The method may include receiving a MIMO transmission that includes N layers, N being an integer that is greater than two, the MIMO transmission including two or more code blocks, an interference-mitigating code block, and a tail code block. The method may include decoding the MIMO transmission based at least in part on, a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block.

Some aspects described herein relate to an apparatus for wireless communication at a transmitter. The apparatus may include one or more memories and one or more processors coupled to the one or more memories. The one or more processors may be configured to map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two. The one or more processors may be configured to map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks. The one or more processors may be configured to transmit the MIMO transmission based at least in part on the mapping of the two or more code blocks and the mapping of the two or more interference-mitigating code blocks.

Some aspects described herein relate to an apparatus for wireless communication at a receiver. The apparatus may include one or more memories and one or more processors coupled to the one or more memories. The one or more processors may be configured to receive a MIMO transmission that includes N layers, N being an integer that is greater than two, the MIMO transmission including two or more code blocks and two or more interference-mitigating code blocks. The one or more processors may be configured to decode the MIMO transmission based at least in part on, a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Some aspects described herein relate to an apparatus for wireless communication at a transmitter. The apparatus may include one or more memories and one or more processors coupled to the one or more memories. The one or more processors may be configured to map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being a first integer greater than two, the N layers being separated into L layer groups of equal size, L being a second integer. The one or more processors may be configured to map an interference-mitigating code block across a first set of (L−1) layer groups based at least in part on the interference-mitigating code block being separated into N interference-mitigating code block partitions. The one or more processors may be configured to map a tail code block across a second set of (L−1) layer groups based at least in part on the tail code block being separated into N tail code block partitions, the mapping of the tail code block being complementary to the mapping of the interference-mitigating code block. The one or more processors may be configured to transmit the MIMO transmission based at least in part on the mapping of the two or more code blocks, the mapping of the interference-mitigating code block, and the mapping of the tail code block.

Some aspects described herein relate to an apparatus for wireless communication at a receiver. The apparatus may include one or more memories and one or more processors coupled to the one or more memories. The one or more processors may be configured to receive a MIMO transmission that includes N layers, N being an integer that is greater than two, the MIMO transmission including two or more code blocks, an interference-mitigating code block, and a tail code block. The one or more processors may be configured to decode the MIMO transmission based at least in part on, a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block.

Some aspects described herein relate to a non-transitory computer-readable medium that stores a set of instructions for wireless communication by a transmitter. The set of instructions, when executed by one or more processors of the transmitter, may cause the transmitter to map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two. The set of instructions, when executed by one or more processors of the transmitter, may cause the transmitter to map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks. The set of instructions, when executed by one or more processors of the transmitter, may cause the transmitter to transmit the MIMO transmission based at least in part on the mapping of the two or more code blocks and the mapping of the two or more interference-mitigating code blocks.

Some aspects described herein relate to a non-transitory computer-readable medium that stores a set of instructions for wireless communication by a receiver. The set of instructions, when executed by one or more processors of the receiver, may cause the receiver to receive a MIMO transmission that includes N layers, N being an integer that is greater than two, the MIMO transmission including two or more code blocks and two or more interference-mitigating code blocks. The set of instructions, when executed by one or more processors of the receiver, may cause the receiver to decode the MIMO transmission based at least in part on, a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Some aspects described herein relate to a non-transitory computer-readable medium that stores a set of instructions for wireless communication by a transmitter. The set of instructions, when executed by one or more processors of the transmitter, may cause the transmitter to map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being a first integer greater than two, the N layers being separated into L layer groups of equal size, L being a second integer. The set of instructions, when executed by one or more processors of the transmitter, may cause the transmitter to map an interference-mitigating code block across a first set of (L−1) layer groups based at least in part on the interference-mitigating code block being separated into N interference-mitigating code block partitions. The set of instructions, when executed by one or more processors of the transmitter, may cause the transmitter to map a tail code block across a second set of (L−1) layer groups based at least in part on the tail code block being separated into N tail code block partitions, the mapping of the tail code block being complementary to the mapping of the interference-mitigating code block. The set of instructions, when executed by one or more processors of the transmitter, may cause the transmitter to transmit the MIMO transmission based at least in part on the mapping of the two or more code blocks, the mapping of the interference-mitigating code block, and the mapping of the tail code block.

Some aspects described herein relate to a non-transitory computer-readable medium that stores a set of instructions for wireless communication by a receiver. The set of instructions, when executed by one or more processors of the receiver, may cause the receiver to receive a MIMO transmission that includes N layers, N being an integer that is greater than two, the MIMO transmission including two or more code blocks, an interference-mitigating code block, and a tail code block. The set of instructions, when executed by one or more processors of the receiver, may cause the receiver to decode the MIMO transmission based at least in part on, a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block.

Some aspects described herein relate to an apparatus for wireless communication. The apparatus may include means for mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two. The apparatus may include means for mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks. The apparatus may include means for transmitting the MIMO transmission based at least in part on the mapping of the two or more code blocks and the mapping of the two or more interference-mitigating code blocks.

Some aspects described herein relate to an apparatus for wireless communication. The apparatus may include means for receiving a MIMO transmission that includes N layers, N being an integer that is greater than two, the MIMO transmission including two or more code blocks and two or more interference-mitigating code blocks. The apparatus may include means for decoding the MIMO transmission based at least in part on, a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Some aspects described herein relate to an apparatus for wireless communication. The apparatus may include means for mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being a first integer greater than two, the N layers being separated into L layer groups of equal size, L being a second integer. The apparatus may include means for mapping an interference-mitigating code block across a first set of (L−1) layer groups based at least in part on the interference-mitigating code block being separated into N interference-mitigating code block partitions. The apparatus may include means for mapping a tail code block across a second set of (L−1) layer groups based at least in part on the tail code block being separated into N tail code block partitions, the mapping of the tail code block being complementary to the mapping of the interference-mitigating code block. The apparatus may include means for transmitting the MIMO transmission based at least in part on the mapping of the two or more code blocks, the mapping of the interference-mitigating code block, and the mapping of the tail code block.

Some aspects described herein relate to an apparatus for wireless communication. The apparatus may include means for receiving a MIMO transmission that includes N layers, N being an integer that is greater than two, the MIMO transmission including two or more code blocks, an interference-mitigating code block, and a tail code block. The apparatus may include means for decoding the MIMO transmission based at least in part on, a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating a first example, a second example, a third example, and a fourth example of code block mapping schemes, in accordance with the present disclosure.

FIGS. 4A and 4B are diagrams illustrating a first example, a second example, and a third example of spatially-coupled multiple-input, multiple-output-based mapping schemes, in accordance with the present disclosure.

FIG. 5 is a diagram illustrating an example of a wireless communication process between a transmitter and a receiver, in accordance with the present disclosure.

FIG. 6 is a diagram illustrating an example process performed, for example, at a transmitter or an apparatus of a transmitter, in accordance with the present disclosure.

FIG. 7 is a diagram illustrating an example process performed, for example, at a receiver or an apparatus of a receiver, in accordance with the present disclosure.

FIG. 8 is a diagram illustrating an example process performed, for example, at a transmitter or an apparatus of a transmitter, in accordance with the present disclosure.

FIG. 9 is a diagram illustrating an example process performed, for example, at a receiver or an apparatus of a receiver, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A transmitter, such as a network node or a user equipment (UE), may use spatially-coupled multiple-input, multiple-output (SC-MIMO) to improve a robustness, reliability, and/or data throughput for a multiple-input, multiple-output (MIMO) transmission in scenarios where there is significant variation in channel conditions across the MIMO layers. More particularly, SC-MIMO may use a mapping scheme that increases a coupling between MIMO layers using a structured dependency between the layers such that a MIMO layer may be decoded using at least some information from another MIMO layer, resulting in increased robustness, reliability, and/or data throughput. To illustrate, a single codeword may be partitioned into multiple independent code blocks, and each independent code block may be partitioned into multiple code block partitions. To increase a coupling between MIMO layers, an SC-MIMO code block mapping scheme may use a structured dependency that maps a first code block partition of a first independent code block to a first layer and a second code block partition of a second independent code block to a second layer such that the first code block partition is transmitted simultaneously with the second code block partition via different layers. A receiver may use successive interference cancellation (SIC) in which the receiver subtracts the first code block partition from the second code block partition (or vice versa) to improve data recovery for the remaining signal, as described below. “Spatial coupling” may denote the inter-layer coupling that is based at least in part on the structured dependency.

Alternatively, or additionally, a transmitter may use MIMO layer grouping to increase data throughput and/or reduce data transfer latencies via a MIMO transmission. To illustrate, for multiple layer MIMO transmission, a transmitter may organize the layers into different layer groups in a manner that enables the transmitter to optimize resource allocations, beamforming, and/or spatial multiplexing in a more efficient manner relative to processing each layer independently. With regard to SC-MIMO code block mapping, the structural dependency may be extended to layer groups, rather than individual layers. For instance, each layer in a layer group may carry a respective code block partition of a same independent code block simultaneously. Based at least in part on a structured dependency with the layer groups and/or a structured inter-layer-group coupling, an additional code block partition of the same independent code block may be mapped to a different layer group and/or transmitted at a different time by the different layer group.

The demand for services provided by a wireless network continues to increase as more and more devices access the wireless network. The availability of communication resources (e.g., frequency resources and/or time resources) to provide these services becomes proportionally strained as the number of devices accessing the wireless network increases. As an added complexity, some devices may request increased data throughput and/or lower data-transfer latency relative to other devices, such as when a device executes an application that consumes large quantities of data and/or has time-sensitive needs (e.g., streaming video, streaming audio, video calling, gaming, and/or emergency services). Accordingly, to meet the demand, wireless communication standards have changed over time to include and evolve MIMO capabilities. To reduce the complexity of implementing MIMO, the communication standards managed the MIMO capabilities by initially supporting a maximum of two layers and/or a maximum of two layer groups. Accordingly, various MIMO techniques, such as SC-MIMO, are configured to support two layers and/or two layer groups, and no more. However, as the demand for more services (e.g., more data throughput and lower data-transfer latencies) grows, the MIMO capabilities supported by a communication standard may also mature and evolve to add support for more than two MIMO layers. Without evolving SC-MIMO to support more than two MIMO layers (and/or two or more MIMO layer groups as described below), the data throughput and/or data transfer latencies gains associated with using more than two MIMO layers in a MIMO transmission may be reduced and/or may be compromised, resulting in reduced data throughput and/or increased data transfer latencies.

Various aspects relate generally to interference-mitigating code block mapping across more than two layers of a MIMO transmission using SC-MIMO. Some aspects more specifically relate to a transmitter device mapping one or more interference-mitigating code blocks across the layers of the MIMO transmission. In some aspects, a transmitter may map two or more code blocks (e.g., of a single codeword) across N layers of a MIMO transmission, where N is an integer greater than two. As one example, each code block of the two or more code blocks may be separated into N code block partitions such that each layer of the N layers is assigned a respective code block partition of the N code block partitions. In some aspects, the transmitter may map the two or more code blocks based at least in part on an SC-MIMO-based mapping scheme that spatially couples the layers such that at least a first portion of a first MIMO layer may be decoded using at least some information from a second portion of a second MIMO layer. Alternatively, or additionally, the transmitter may map two or more interference-mitigating code blocks across the N layers of the MIMO transmission. In some cases, the transmitter may separate each interference-mitigating code block into N interference-mitigating code block partitions and may map a respective interference-mitigating code block partition of the N interference-mitigating code block partitions to a respective layer of the N layers. The mapping of the two or more interference-mitigating code blocks may be complementary to the mapping of the two or more code blocks. Based at least in part on mapping the two or more code blocks and the two or more interference-mitigating code blocks, the transmitter may transmit the MIMO transmission.

In some aspects, a receiver may receive a MIMO transmission that includes N layers, N being an integer that is greater than two. The MIMO transmission may include two or more code blocks and two or more interference-mitigating code blocks. The receiver may decode the MIMO transmission based at least in part on a first mapping of the two or more code blocks across the N layers of the MIMO transmission. For instance, each code block of the two or more code blocks may be separated into N code block partitions such that each layer of the N layers includes a respective code block partition of the N code block partitions. In some aspects, the first mapping of the two or more code blocks may be based at least in part on an SC-MIMO-based mapping scheme. Alternatively, or additionally, the receiver may decode the MIMO transmission based at least in part on a second mapping of the two or more interference-mitigating code blocks across the N layers of the MIMO transmission. For example, each interference-mitigating code block may be separated into N interference-mitigating code block partitions such that each layer of the N layers includes a respective interference-mitigating code block partition of the N code block partitions. In some aspects, the second mapping of the two or more interference-mitigating code blocks may be complementary to the first mapping of the two or more code blocks.

In some aspects, a transmitter may map two or more code blocks across N layers of a MIMO transmission, N being an integer greater than two. As one example, the transmitter may separate each code block of the two or more code blocks into N code block partitions such that each layer of the N layers is assigned a respective code block partition of the N code block partitions. In some aspects, the N layers are separated into L layer groups of equal size, L being a second integer, and the mapping of the two or more code blocks by the transmitter is based at least in part on an SC-MIMO-based mapping scheme. Alternatively, or additionally, the transmitter may map an interference-mitigating code block across a first set of (L−1) layer groups based at least in part on the interference-mitigating code block being separated into N interference-mitigating code block partitions. The transmitter may also map a tail code block across a second set of (L−1) layer groups based at least in part on the tail code block being separated into N tail code block partitions, and the mapping of the tail code block may be complementary to the mapping of the interference-mitigating code block. The transmitter may transmit the MIMO transmission based at least in part on the mapping of the two or more code blocks, the mapping of the interference-mitigating code block, and the mapping of the tail code block.

In some aspects, a receiver may receive a MIMO transmission that includes N layers, N being an integer that is greater than two, and the N layers may be separated into L layer groups of equal size, L being a second integer. The MIMO transmission may include two or more code blocks, an interference-mitigating code block, and a tail code block. Based at least in part on the MIMO transmission including two or more code blocks, the interference-mitigating code block, and the tail code block, the receiver may decode the MIMO transmission based at least in part on a first mapping of the two or more code blocks across the N layers of the MIMO transmission, where each code block of the two or more code blocks is separated into N code block partitions such that each layer of the N layers is assigned a respective code block partition of the N code block partitions. In some aspects, the first mapping of the two or more code blocks may be based at least in part on an SC-MIMO-based mapping scheme. MIMO transmission may also be based at least in part on a second mapping of the interference-mitigating code block across a first set of (L−1) layer groups based at least in part on the interference-mitigating code block being separated into N interference-mitigating code block partitions. In some aspects, the MIMO transmission may also be based at least in part on a third mapping of the tail code block across a second set of (L−1) layer groups based at least in part on the tail code block being separated into N tail code block partitions. The mapping of the tail code block may be complementary to the mapping of the interference-mitigating code block.

Particular aspects of the subject matter described in this disclosure can be implemented to realize one or more of the following potential advantages. In some examples, by mapping two or more interference-mitigating code blocks across more than two layers of a MIMO transmission, the described techniques can be used to enable a transmitter to use an SC-MIMO-based mapping scheme that includes structural dependency for MIMO transmissions that have more than two MIMO layers and/or across more than two layer groups. Alternatively, or additionally, using an SC-MIMO-based mapping scheme that uses a structural dependency for a MIMO transmission that includes more than two layers and/or more than two layer groups enables a receiver to use SIC in data recovery for the MIMO transmission and, consequently, reduce recovery errors at the receiver. Reducing recovery errors at the receiver for a MIMO transmission with more than two layers and/or more than two layer groups may result in increased data throughput and/or reduced data transfer latencies.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

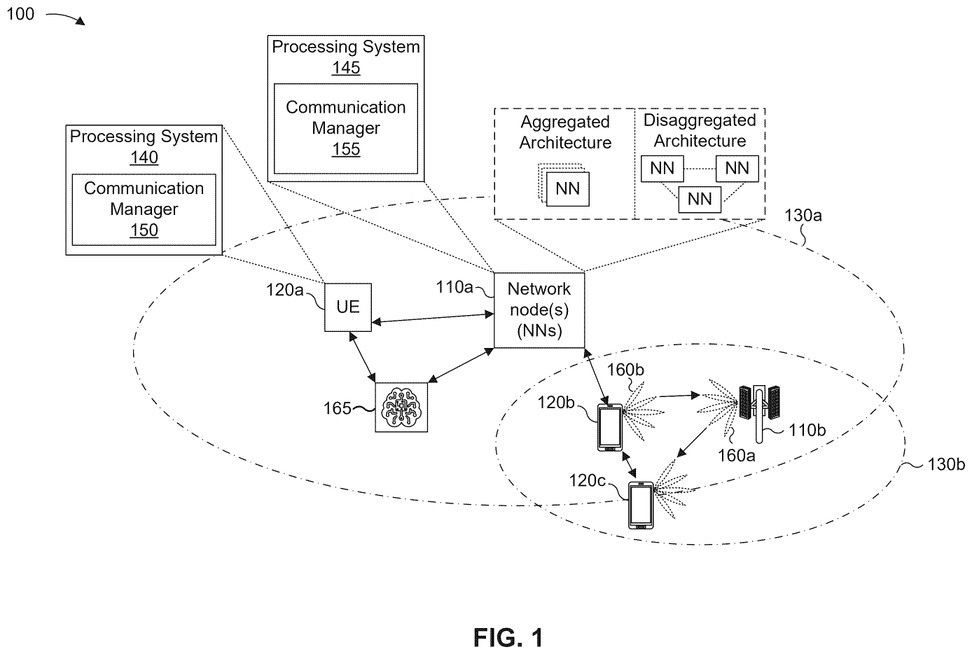

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FRI is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) (for example, which may referred to as “one or more code-storing memories” or “code-storing memory circuitry”). The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

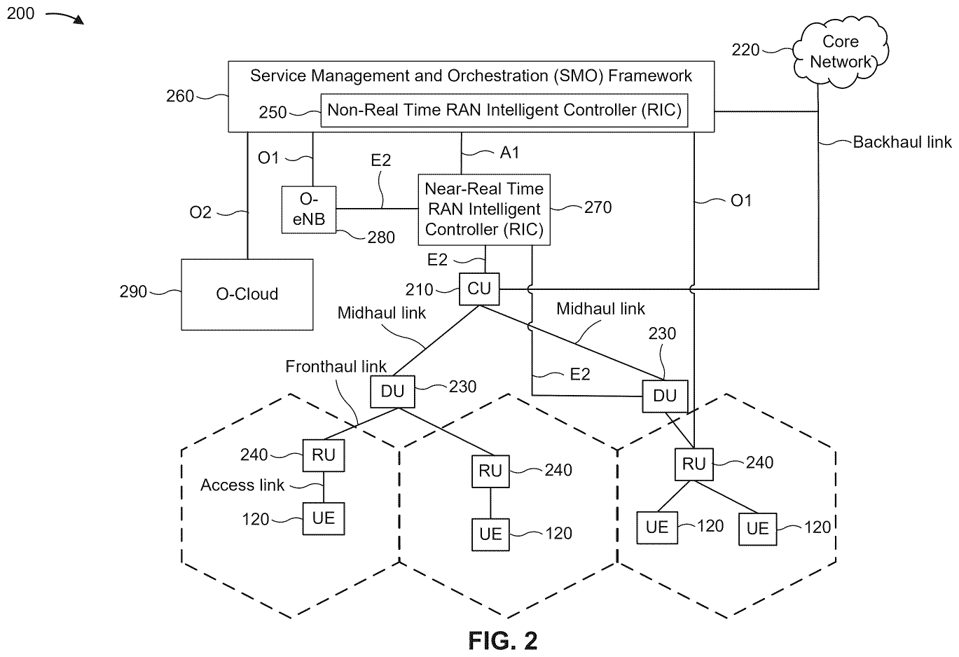

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., a UE 120) may include a communication manager 150. As described in more detail elsewhere herein, and based at least in part on the UE acting as a transmitter, the communication manager 150 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two; map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks; and transmit the MIMO transmission based at least in part on the mapping of the two or more code blocks and the mapping of the two or more interference-mitigating code blocks.

Alternatively, or additionally, and based at least in part on the UE acting as a transmitter, the communication manager 150 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, the N layers being separated into L layer groups of equal size, L being a second integer; map an interference-mitigating code block across a first set of (L−1) layer groups based at least in part on the interference-mitigating code block being separated into N interference-mitigating code block partitions; map a tail code block across a second set of (L−1) layer groups based at least in part on the tail code block being separated into N tail code block partitions, the mapping of the tail code block being complementary to the mapping of the interference-mitigating code block; and transmit the MIMO transmission based at least in part on the mapping of the two or more code blocks, the mapping of the interference-mitigating code block, and the mapping of the tail code block.

Alternatively, or additionally, and based at least in part on the UE acting as a receiver, the communication manager 150 may receive a MIMO transmission that includes N layers, N being an integer that is greater than two, the MIMO transmission including two or more code blocks and two or more interference-mitigating code blocks; and decode the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Alternatively, or additionally, and based at least in part on the UE acting as a receiver, the communication manager 150 may receive a MIMO transmission that includes N layers, N being an integer that is greater than two, the MIMO transmission including two or more code blocks, an interference-mitigating code block, and a tail code block; and decode the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block. Additionally, or alternatively, the communication manager 150 may perform one or more other operations described herein.

In some aspects, a network node (e.g., a network node 110) may include a communication manager 155. As described in more detail elsewhere herein, and based at least in part on the network node acting as a transmitter, the communication manager 155 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two; map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks; and transmit the MIMO transmission based at least in part on the mapping of the two or more code blocks and the mapping of the two or more interference-mitigating code blocks.

Alternatively, or additionally, and based at least in part on the network node acting as a transmitter, the communication manager 155 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, the N layers being separated into L layer groups of equal size, L being a second integer; map an interference-mitigating code block across a first set of (L−1) layer groups based at least in part on the interference-mitigating code block being separated into N interference-mitigating code block partitions; map a tail code block across a second set of (L−1) layer groups based at least in part on the tail code block being separated into N tail code block partitions, the mapping of the tail code block being complementary to the mapping of the interference-mitigating code block; and transmit the MIMO transmission based at least in part on the mapping of the two or more code blocks, the mapping of the interference-mitigating code block, and the mapping of the tail code block.

Alternatively, or additionally, and based at least in part on the network node acting as a receiver, the communication manager 155 may receive a MIMO transmission that includes N layers, N being an integer that is greater than two, the MIMO transmission including two or more code blocks and two or more interference-mitigating code blocks; and decode the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Alternatively, or additionally, and based at least in part on the network node acting as a receiver, the communication manager 155 may receive a MIMO transmission that includes N layers, N being an integer that is greater than two, the MIMO transmission including two or more code blocks, an interference-mitigating code block, and a tail code block; and decode the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

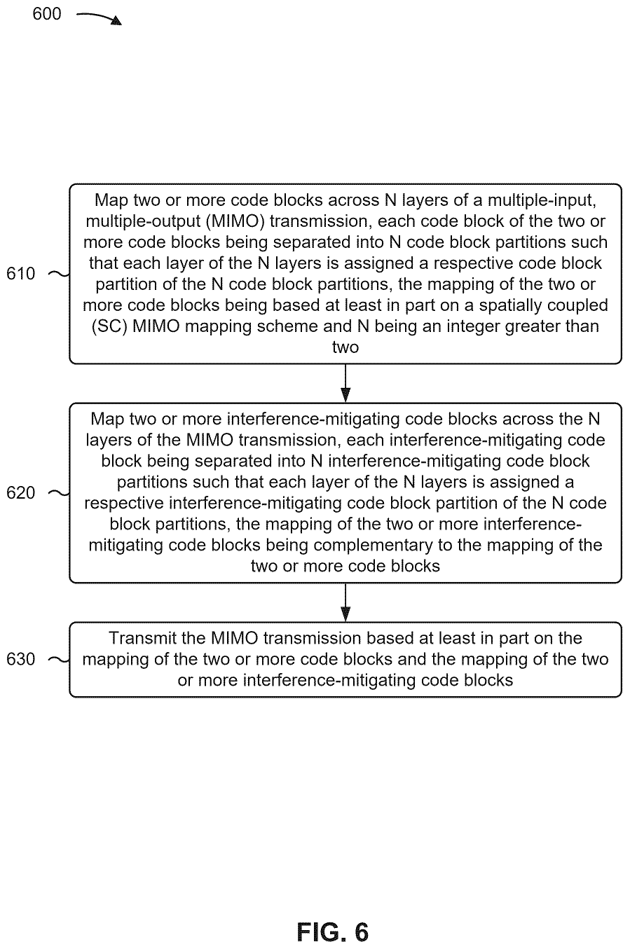

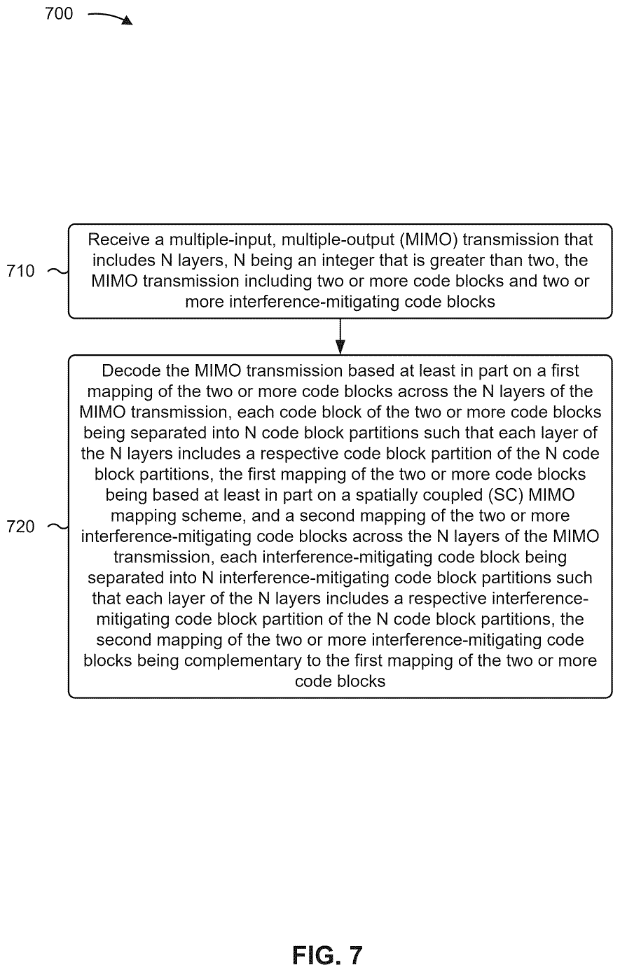

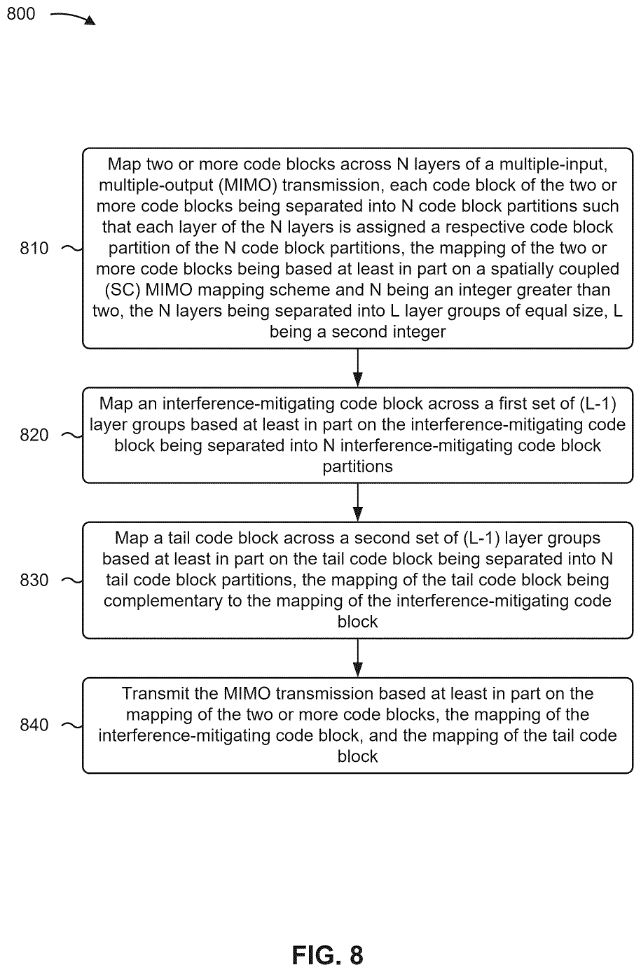

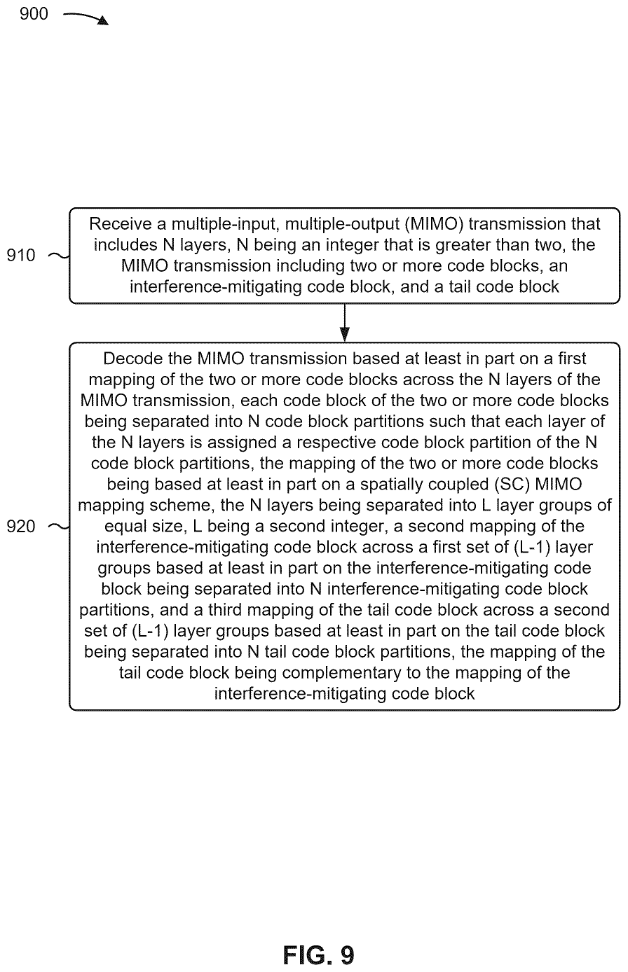

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with interference-mitigating code block mapping across more than two layers of a MIMO transmission using SC-MIMO, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, a UE (e.g., a UE 120) is a transmitter and includes means for mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two; means for mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks; and/or means for transmitting the MIMO transmission based at least in part on the mapping of the two or more code blocks and the mapping of the two or more interference-mitigating code blocks.

Alternatively, or additionally, based at least in part on the UE being a transmitter, the UE includes means for mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, the N layers being separated into L layer groups of equal size, L being a second integer; means for mapping an interference-mitigating code block across a first set of (L−1) layer groups based at least in part on the interference-mitigating code block being separated into N interference-mitigating code block partitions; means for mapping a tail code block across a second set of (L−1) layer groups based at least in part on the tail code block being separated into N tail code block partitions, the mapping of the tail code block being complementary to the mapping of the interference-mitigating code block; and/or means for transmitting the MIMO transmission based at least in part on the mapping of the two or more code blocks, the mapping of the interference-mitigating code block, and the mapping of the tail code block

Alternatively, or additionally, the UE is a receiver and includes means for receiving a MIMO transmission that includes N layers, N being an integer that is greater than two, the MIMO transmission including two or more code blocks and two or more interference-mitigating code blocks; and/or means for decoding the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

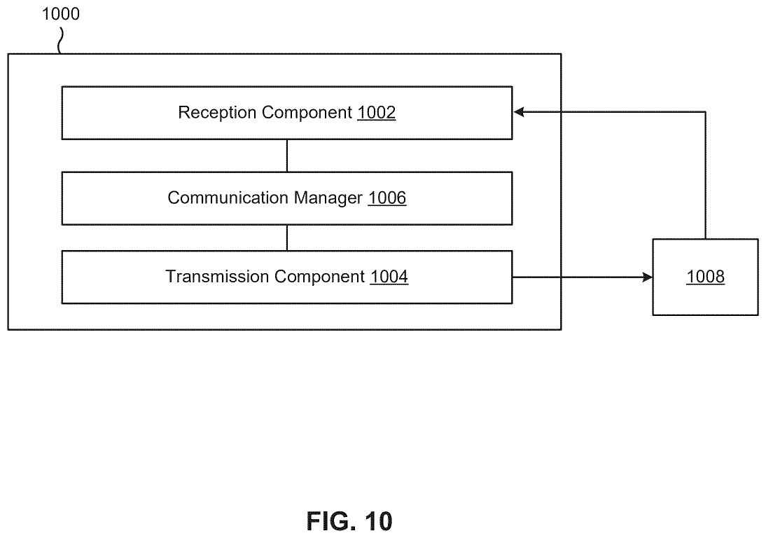

Alternatively, or additionally, and based at least in part on being a receiver, the UE includes means for receiving a MIMO transmission that includes N layers, N being an integer that is greater than two, the MIMO transmission including two or more code blocks, an interference-mitigating code block, and a tail code block; and/or means for decoding the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block. In some aspects, the means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

In some aspects, a network node (e.g., a network node 110) is a transmitter and includes means for mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two; means for mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks; and/or means for transmitting the MIMO transmission based at least in part on the mapping of the two or more code blocks and the mapping of the two or more interference-mitigating code blocks.

Alternatively, or additionally, based at least in part on the network node being a transmitter, the network node includes means for mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, the N layers being separated into L layer groups of equal size, L being a second integer; means for mapping an interference-mitigating code block across a first set of (L−1) layer groups based at least in part on the interference-mitigating code block being separated into N interference-mitigating code block partitions; means for mapping a tail code block across a second set of (L−1) layer groups based at least in part on the tail code block being separated into N tail code block partitions, the mapping of the tail code block being complementary to the mapping of the interference-mitigating code block; and/or means for transmitting the MIMO transmission based at least in part on the mapping of the two or more code blocks, the mapping of the interference-mitigating code block, and the mapping of the tail code block

Alternatively, or additionally, the network node is a receiver and includes means for receiving a MIMO transmission that includes N layers, N being an integer that is greater than two, the MIMO transmission including two or more code blocks and two or more interference-mitigating code blocks; and/or means for decoding the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

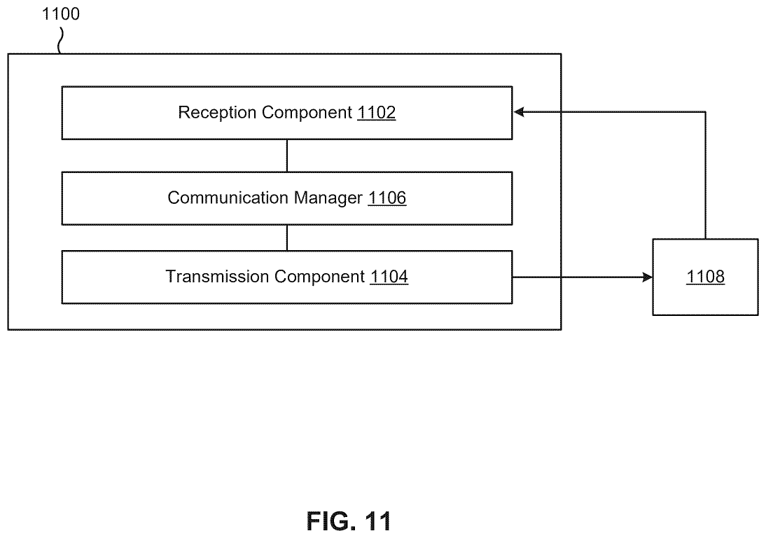

Alternatively, or additionally, based at least in part on being a receiver, the network node includes means for receiving a MIMO transmission that includes N layers, N being an integer that is greater than two, the MIMO transmission including two or more code blocks, an interference-mitigating code block, and a tail code block; and/or means for decoding the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block. In some aspects, the means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

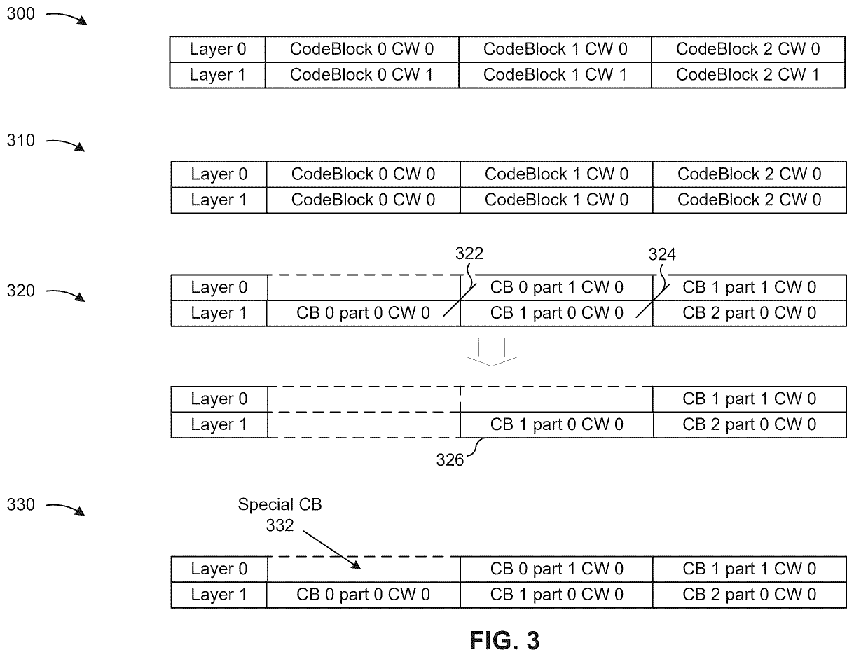

FIG. 3 is a diagram illustrating a first example 300, a second example 310, a third example 320, and a fourth example 330 of code block mapping schemes, in accordance with the present disclosure.

In a MIMO system, a transmitter and receiver may simultaneously communicate multiple data streams with one another. As one example, the transmitter may use beamforming to simultaneously transmit a first data stream via a first beam and a second data stream via a second beam. To beamform the data streams via separate beams, the transmitter may apply a first set of precoding weights to a first signal associated with the first data stream such that each antenna of an antenna array transmits respective first signals that, when combined, form the first beam. Similarly, the transmitter may apply a second set of precoding weights to a second signal associated with the second data stream such that each antenna of the antenna array transmits respective second signals that, when combined, form the second beam. In combination, the first signal and the second signal may form a MIMO transmission, and each data stream and/or each signal may be referred to as a layer of the MIMO transmission. A number and/or quantity of layers in a MIMO transmission may affect data rate and system performance. For instance, more layers enable the MIMO transmission to carry more independent data streams, resulting in an increased overall throughput and/or a decreased data transfer latency.

To mitigate recovery errors and/or increase error correction capabilities in a wireless network, raw user data in a data stream may be processed in multiple steps prior to transmission. For instance, the raw user data may first be segmented into one or more TBs, where each TB is a data unit that is processed by a protocol layer. Channel encoding (e.g., via a polar code, a turbo code, and/or an LDPC) may be applied to each TB, resulting in a codeword (CW). In some cases, the transmitter may transmit a codeword based at least in part on partitioning the codeword into code blocks, and each code block may be independently processed to apply respective error correction and/or append respective cyclic redundancy check (CRC) bits to the code block.

With regard to a MIMO transmission, a transmitter may map a codeword (and the corresponding code blocks) to a same MIMO layer or different MIMO layers. To illustrate, the first example 300 shows a long term evolution (LTE) dual CW MIMO-based mapping scheme for mapping multiple CWs to multiple layers, such as Layer 0 and Layer 1 of a MIMO transmission. For instance, LTE specifies a first codeword, CW0, as a primary codeword and/or a primary data stream. Single layer transmissions, such as a single-input, single-output (SISO) transmission, always and only carry CW0. LTE also specifies a second codeword, CW1, as a secondary codeword and/or a secondary data stream that is separate and independent of the first codeword CW0. Accordingly, every channel may carry and/or use CW0, and channels that are configured to carry multiple layers, such as PDSCH, may additionally carry CW1 (e.g., for user data). Alternatively, or additionally, MIMO transmissions (e.g., that use spatial multiplexing and/or polarization multiplexing) may carry both CW0 and CW1 in different layers.

The first code block mapping scheme in the first example 300 may be referred to as an LTE dual CW mapping scheme that is based at least in part on time-frequency resources that are allocated to a MIMO transmission. To illustrate, the first example 300 includes two rows of time-frequency resources: a first row of time-frequency resources that are allocated to Layer 0 of the MIMO transmission and a second row of time-frequency resources that are allocated to Layer 1 of the MIMO transmission. The time-frequency resources for each row are partitioned into respective code block resources, and the code block resources may include and/or represent one or more time-frequency resources. To illustrate, a first code block resource in the Layer 0 row (e.g., a first partition) may include and/or represent one or more first time-frequency resources that are allocated to a first portion of a Layer 0 data transmission (e.g., a first code block carried by Layer 0). In a similar manner, a second code block resource in the Layer 0 row (e.g., a second partition) may include and/or represent one or more second time-frequency resources that are allocated to a second portion of the Layer 0 data transmission (e.g., a second code block carried by Layer 0), and the third code block resource in the Layer 0 row (e.g., a third partition) may include and/or represent one or more third time-frequency resources that are allocated to a third portion of the Layer 0 data transmission. A time-frequency resource and, consequently, a code block resource, may be based at least in part on any type of frequency partition and/or any type of time partition, such as a carrier, a sub-carrier, a sub-band, an RB, a resource element (RE), a time slot, a symbol, and/or a mini slot. In some cases, the code block resources between layers may share one or more time-frequency resources based at least in part on a MIMO transmission using a multiplexing scheme (e.g., spatial multiplexing, polarization multiplexing) that separates each layer. Accordingly, a first code block resource in Layer 0 may share one or more time-frequency resources with a first code block resource in Layer 1.

In the LTE dual CW mapping scheme, a transmitter may partition CW0 into a first set of code blocks (shown as CodeBlock 0 CW0, CodeBlock 1 CW0, and CodeBlock 2 CW0), and CW1 into a second set of code blocks (shown as CodeBlock 0 CW1, CodeBlock 1 CW1, and CodeBlock 2 CW1). Based at least in part on using the first code block mapping scheme, the transmitter may assign CW0 to a first layer (e.g., Layer 0) such that each code block of CW0 is mapped to (and subsequently carried by) a respective code block resource of Layer 0. The transmitter may also assign each code block of CW1 to a second layer (e.g., Layer 1) such that each code block of CW1 is mapped to (and subsequently carried by) a respective code block resource of Layer 1. In some cases, the transmitter may use different code rates and/or modulation schemes (e.g., different MCSs) for the Layer 0/CW0 transmission and the Layer 1/CW1 transmission.

A receiver may decode and/or recover CW0 and CW1 based at least in part on using successive interference cancellation (SIC) and/or hard SIC (HSIC). For instance, the receiver may receive a first signal and a second signal as a combined signal, such as Layer 0 and Layer 1 of a MIMO transmission. The receiver may decode the first signal and subtract the first signal from the combined signal to generate a difference signal. The receiver may then decode the difference signal as the second signal. Accordingly, in using SIC to decode and/or recover CW0 and CW1 from the first signal and the second signal, the receiver may iteratively subtract detected signals from a combined signal to improve the detection of the remaining signal (e.g., the difference signal). Using the LTE dual CW mapping scheme of the first example 300 in combination with SIC signal processing may enable a transmitter and receiver to achieve (or approach) a MIMO capacity. Alternatively, or additionally, the receiver may use linear minimum mean squared error (LMMSE) signal processing to improve data recovery (e.g., reduce receiver errors) in decoding the first signal and improve the effectiveness of SIC in subsequent signal decoding. Approaching and/or achieving the MIMO capacity through the use of LTE dual CW mapping may, in some cases, be based at least in part on per-CW CQI feedback having a certain amount of accuracy within a time threshold and/or using separate outer-loop control mechanisms that adjust a target CQI for each CW.

The second example 310 shown by FIG. 3 is a second code block mapping scheme that may be referred to as a single CW mapping with an irregular LDPC and/or as a NR single CW0 mapping scheme. The second code block mapping scheme in the second example 310 may be based at least in part on time-frequency resources that are allocated to a MIMO transmission in a similar manner as described with regard to the first example 300 (e.g., code block resources).

As shown by FIG. 3, a transmitter may partition the single CW0 into multiple code blocks and/or may partition each code block into multiple code block partitions. The transmitter may then map a respective code block partition to a respective layer of a MIMO transmission. For instance, with regard to a 2-layer MIMO transmission, the transmission may assign a first code block partition of a first code block to Layer 0 and a second code block partition of the first code block to Layer 1, which is shown by FIG. 3 as CodeBlock 0 CW0 assigned to Layer 0 and CodeBlock 0 CW0 assigned to Layer 1, respectively. The transmitter may repeat the code block partitioning for each code block of CW0 such that each layer is assigned a respective code block partition of each code block, which is further shown by FIG. 3 as CodeBlock 1 CW0 assigned to Layer 0, CodeBlock 1 CW0 assigned to Layer 1, CodeBlock 2 CW0 assigned to Layer 0, and CodeBlock 2 CW0 assigned to Layer 1.

In the second example 310, each layer transmission may be independent from one another such that a receiver may decode each layer independently and/or without using information from the other layers. Alternatively, or additionally, each layer may be assigned a respective MCS and/or may experience different channel conditions relative to one another. To reduce decoding errors and/or to increase data throughput in a manner that results in a MIMO transmission that approaches and/or achieves a MIMO capacity, a receiver may use non-linear MIMO demodulation techniques, such as iterative SIC, across all of the MIMO layers. However, based at least in part on a transmitter using different MCSs for each layer, a MIMO transmission may deviate from an assumption of uniformly distributed noise (e.g., additive white Gaussian noise (AWGN)). This deviation may make NR LDPC decoding suboptimal for iterative demodulation or decoding processes. Consequently, the NR single CW0 mapping scheme in NR in the second example 310 may be suboptimal relative to an LTE dual CW mapping scheme in some scenarios, such as scenarios in which there is significant channel condition variation across the layers. That is, a MIMO transmission that is based at least in part on LDPC encoding/decoding may achieve higher data throughput using the LTE dual CW mapping scheme relative to the NR single CW 0 mapping scheme in scenarios in which there is significant variation in the channel conditions across the layers.

A transmitter may use spatially-coupled (SC)-MIMO to improve a robustness, reliability, and/or data throughput for LDPC-based MIMO transmissions in scenarios where there is significant variation in channel conditions across the MIMO layers. More particularly, SC-MIMO may use a mapping scheme that increases a coupling between MIMO layers using a structured dependency between the layers such that a MIMO layer may be decoded using at least some information from another MIMO layer, resulting in increased robustness, reliability, and/or data throughput. To illustrate, a single codeword (e.g., CW0) may be partitioned into multiple independent code blocks, and each independent code block may be partitioned into multiple code block partitions. To increase a coupling between MIMO layers, an SC-MIMO code block mapping scheme may use a structured dependency that maps a first code block partition of a first independent code block to a first layer and a second code block partition of a second independent code block to a second layer such that the first code block partition is transmitted simultaneously with the second code block partition via different layers. A receiver may use SIC to subtract the first code block partition from the second code block partition (or vice versa) to improve data recovery for the remaining signal “Spatial coupling” may denote the inter-layer coupling that is based at least in part on the structured dependency.

The third example 320 is an example of a third code block mapping scheme that may also be referred to as an SC-MIMO-based mapping scheme for a single CW0. The third code block mapping scheme shown by FIG. 3 may be based at least in part on the time-frequency resources and/or the code block resources described with regard to the first example 300 and the second example 310. In some aspects, a transmitter using an SC-MIMO-based mapping scheme may select a single CW rate (e.g., a uniform MCS for all layers) to match a collective channel quality across the multiple layers of a MIMO transmission.

In a similar manner as described with regard to the second example 310, a transmitter may partition each code block of a single CW (e.g. CW0) into code block partitions and may map a respective code block partition of each code block to a respective layer of a MIMO transmission. As shown by FIG. 3, the third code block mapping scheme of the third example 320 may be based at least in part on a structured dependency and/or a spatial coupling between the different MIMO layers such that at least a first portion of a first MIMO layer may be decoded using at least some information from a second portion of a second MIMO layer.

To illustrate, as shown by FIG. 3, Layer 0 and Layer 1 may each be assigned three respective code block resources in a similar manner as described above: a first Layer 0 code block resource and a first Layer 1 code block resource, a second Layer 0 code block resource and a second Layer 1 code block resource, and a third Layer 0 code block resource and a third Layer 1 code block resource. Each code block resource may include and/or represent one or more time-frequency resources that are assigned to the respective MIMO layer. In some aspects, a transmitter may map code block partitions of a code block across different MIMO layers using the structured dependency between the code block resources. For instance, based at least in part on a first structured dependency 322, the transmitter may map a first code block partition of a first code word to a first code block resource of Layer 1 (shown as CB 0 part 0 CW0) and a second code block partition of the first code word to a second code block resource of Layer 0 (shown as CB 0 part 1 CW0). Alternatively, or additionally, based at least in part on a second structured dependency 324, the transmitter may map a first code block partition of a second code block to a second code block resource of Layer 1 (shown as CB1 part 0 CW0) and a second code block partition of the second code block (shown as CB1 part 1 CW0) to a third code block resource of Layer 0.

A receiver may decode and/or de-map the information carried in the code block resources (e.g., the code block partitions) based at least in part on the structured dependencies that enable the receiver to use SIC as at least part of a demodulating process and/or a decoding process. For instance, the receiver may begin the decoding process by decoding a first code block (e.g., in the first code block resource of Layer 1 and the second code block resource of Layer 0). Based at least in part on successful decoding, the receiver may subtract the first code block from a composite received signal to obtain a difference signal as shown by reference number 326, and may demodulate and/or decode a second code block using the second code block resource of Layer 1 and the third code block resource of Layer 0. Based at least in part on successful decoding, the receiver may repeat the process of subtracting the most recently decoded signal from the composite received signal and demodulating/decoding the difference signal until all of the code blocks are successfully decoded or a code block decoding failure is declared.

Some mapping schemes for SC-MIMO may include a special code block, which may also be referred to as an interference-mitigating code block, that is designed to enable successful decoding without the use of SIC by a receiver. For instance, an interference-mitigating code block and/or a special code block may be transmitted with a reduced transmit power level and/or with a lower MCS relative to another code block being simultaneously transmitted via another layer. The fourth example 330 shown by FIG. 3 is an example SC-MIMO-based mapping scheme that is similar to the SC-MIMO-based mapping scheme in which the transmitter places a special code block 332 in a code block resource that is linked to a decoding start. For instance, a receiver may begin decoding in a first code block resource of Layer 1 (e.g., CB 0 part 0 CW0) and a second code block resource of Layer 0. To mitigate interference with the first portion of the first code block carried by Layer 1 in the first code block resource, the transmitter may transmit the special code block 332 in a first code block resource of Layer 0 (e.g., simultaneously with the first code block carried by Layer 1). For example, the transmitter may transmit the special code block 332 with a reduced transmit power level relative to a transmission in the first code block resource of Layer 1. Based at least in part on successful decoding of the first code block, the receiver may perform successive decoding based at least in part on SIC in a similar manner as described above. The successive decoding by the receiver may be performed in a single direction (e.g., starting at the first code block resource and ending at the third code block resource), or may be performed in both directions in parallel (e.g., starting at both the first code block resource and the third code block resource). Alternatively, or additionally, a receiver may change a decoding direction based at least in part on observing a decoding failure.

In some aspects, a transmitter may use MIMO layer grouping to increase data throughput and/or reduce data transfer latencies via a MIMO transmission. To illustrate, for multiple layer MIMO transmission, a transmitter may organize the layers into different layer groups in a manner that enables the transmitter to optimize resource allocations, beamforming, and/or spatial multiplexing in a more efficient manner relative to processing each layer independently. With regard to SC-MIMO code block mapping, the structural dependency may be extended to layer groups, rather than individual layers. For instance, each layer in a layer group may carry a respective code block partition of a same independent code block simultaneously. Based at least in part on a structured dependency with the layer groups and/or a structured inter-layer-group coupling, an additional code block partition of the same independent code block may be mapped to a different layer group and/or transmitted at a different time by the different layer group.

The demand for services provided by a wireless network continues to increase as more and more devices access the wireless network. As described above, to meet the demand, wireless communication standards, such as 3GPP standards, have changed over time to include and evolve MIMO capabilities and managed the MIMO capabilities by initially supporting a maximum of two layers and/or a maximum of two layer groups. Accordingly, various MIMO techniques, such as SC-MIMO, are configured to support two layers and/or two layer groups, and no more. Without evolving SC-MIMO to support more than two layers more than two layer groups, the data throughput and/or data transfer latencies gains associated with using more than two layers and/or more that two layer groups in a MIMO transmission may be reduced and/or may be compromised, resulting in reduced data throughput and/or increased data transfer latencies.

Various aspects relate generally to interference-mitigating code block mapping across more than two layers of a MIMO transmission using SC-MIMO. Some aspects more specifically relate to a transmitter device mapping one or more interference-mitigating code blocks across the layers of the MIMO transmission. In some aspects, a transmitter may map two or more code blocks (e.g., of a single codeword) across N layers of a MIMO transmission, where Nis an integer greater than two. As one example, each code block of the two or more code blocks may be separated into N code block partitions such that each layer of the N layers is assigned a respective code block partition of the N code block partitions. In some aspects, the transmitter may map the two or more code blocks based at least in part on an SC-MIMO-based mapping scheme that spatially couples the layers such that at least a first portion of a first MIMO layer may be decoded using at least some information from a second portion of a second MIMO layer. Alternatively, or additionally, the transmitter may map two or more interference-mitigating code blocks across the N layers of the MIMO transmission. In some cases, the transmitter may separate each interference-mitigating code block into N interference-mitigating code block partitions and may map a respective interference-mitigating code block partition of the N interference-mitigating code block partitions to a respective layer of the N layers. The mapping of the two or more interference-mitigating code blocks may be complementary to the mapping of the two or more code blocks. Based at least in part on mapping the two or more code blocks and the two or more interference-mitigating code blocks, the transmitter may transmit the MIMO transmission.

In some aspects, a receiver may receive a MIMO transmission that includes N layers, N being an integer that is greater than two. The MIMO transmission may include two or more code blocks and two or more interference-mitigating code blocks. The receiver may decode the MIMO transmission based at least in part on a first mapping of the two or more code blocks across the N layers of the MIMO transmission. For instance, each code block of the two or more code blocks may be separated into N code block partitions such that each layer of the N layers includes a respective code block partition of the N code block partitions. In some aspects, the first mapping of the two or more code blocks may be based at least in part on an SC-MIMO-based mapping scheme. Alternatively, or additionally, the receiver may decode the MIMO transmission based at least in part on a second mapping of the two or more interference-mitigating code blocks across the N layers of the MIMO transmission. For example, each interference-mitigating code block may be separated into N interference-mitigating code block partitions such that each layer of the N layers includes a respective interference-mitigating code block partition of the N code block partitions. In some aspects, the second mapping of the two or more interference-mitigating code blocks may be complementary to the first mapping of the two or more code blocks.

In some aspects, a transmitter may map two or more code blocks across N layers of a MIMO transmission, N being an integer greater than two. As one example, the transmitter may separate each code block of the two or more code blocks into N code block partitions such that each layer of the N layers is assigned a respective code block partition of the N code block partitions. In some aspects, the N layers are separated into L layer groups of equal size, L being a second integer, and the mapping of the two or more code blocks by the transmitter is based at least in part on an SC-MIMO-based mapping scheme. Alternatively, or additionally, the transmitter may map an interference-mitigating code block across a first set of (L−1) layer groups based at least in part on the interference-mitigating code block being separated into N interference-mitigating code block partitions. The transmitter may also map a tail code block across a second set of (L−1) layer groups based at least in part on the tail code block being separated into N tail code block partitions, and the mapping of the tail code block may be complementary to the mapping of the interference-mitigating code block. The transmitter may transmit the MIMO transmission based at least in part on the mapping of the two or more code blocks, the mapping of the interference-mitigating code block, and the mapping of the tail code block.

In some aspects, a receiver may receive a MIMO transmission that includes N layers, N being an integer that is greater than two, and the N layers may be separated into L layer groups of equal size, L being a second integer. The MIMO transmission may include two or more code blocks, an interference-mitigating code block, and a tail code block. Based at least in part on the MIMO transmission including two or more code blocks, the interference-mitigating code block, and the tail code block, the receiver may decode the MIMO transmission based at least in part on a first mapping of the two or more code blocks across the N layers of the MIMO transmission, where each code block of the two or more code blocks is separated into N code block partitions such that each layer of the N layers is assigned a respective code block partition of the N code block partitions. In some aspects, the first mapping of the two or more code blocks may be based at least in part on an SC-MIMO-based mapping scheme. MIMO transmission may also be based at least in part on a second mapping of the interference-mitigating code block across a first set of (L−1) layer groups based at least in part on the interference-mitigating code block being separated into N interference-mitigating code block partitions. In some aspects, the MIMO transmission may also be based at least in part on a third mapping of the tail code block across a second set of (L−1) layer groups based at least in part on the tail code block being separated into N tail code block partitions. The mapping of the tail code block may be complementary to the mapping of the interference-mitigating code block.

Particular aspects of the subject matter described in this disclosure can be implemented to realize one or more of the following potential advantages. In some examples, by mapping two or more interference-mitigating code blocks across more than two layers of a MIMO transmission, the described techniques can be used to enable a transmitter to use an SC-MIMO-based mapping scheme that includes structural dependency for MIMO transmissions that have more than two MIMO layers and/or more than two layer groups. Alternatively, or additionally, the use a structural dependency for more than two layers and/or more than two layer groups enables a receiver to use SIC in data recovery for the MIMO transmission and, consequently, reduce recovery errors at the receiver. Reducing recovery errors at the receiver for a MIMO transmission with greater than two layers and/or more than two layer groups may result in increased data throughput and/or reduced data transfer latencies.

As indicated above, FIG. 3 is provided as an example. Other examples may differ from what is described with regard to FIG. 3.

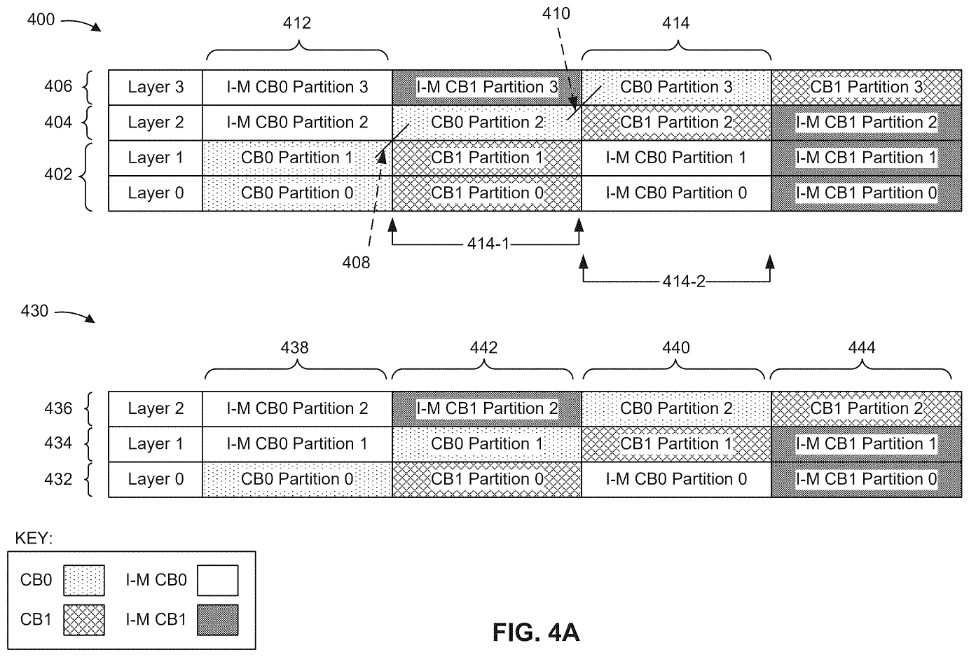

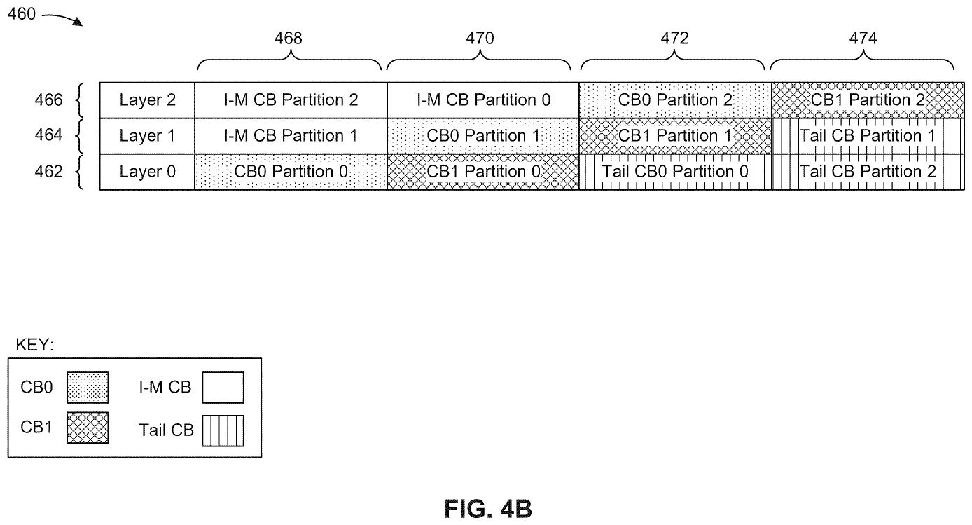

FIGS. 4A and 4B are diagrams illustrating a first example 400, a second example 430, and a third example 460 of SC-MIMO-based mapping schemes, in accordance with the present disclosure.

The first example 400 is a first SC-MIMO-based mapping scheme (which may also be referred to as a code block mapping scheme) for a MIMO transmission that includes three layer groups that are based at least in part on four MIMO layers. To illustrate, the first example 400 includes a first row of code block resources that are assigned to Layer 0, a second row of code block resources assigned to Layer 1, a third row of code block resources that are assigned to Layer 1, and a fourth row of code block resources that are assigned to Layer 4, where the code block resources in the first example 400 may be similar to the code block resources described with regard to FIG. 3. That is, each code block resource may include and/or represent one or more time-frequency resources that are allocated to the respective layer. The four layers in the first example 400 have been organized into three layer groups: a first layer group 402 that includes Layer 0 and Layer 1, a second layer group 404 that includes Layer 2, and a third layer group 406 that includes Layer 3. Accordingly, the layer groups in the first example 400 are unequal insofar as the layer groups do not all include a same quantity of layers. A number (e.g., quantity) of layer groups included in a MIMO transmission may be selected by a transmitter based at least in part on a variety of factors. As one example, the number of layer groups may be based at least in part on a quantity of layers per transport block (e.g., a maximum number of possible layers per transport block by the transmitter), a maximum supported number of layers per layer group (e.g., by a receiver), or a combination of both.

As shown by FIG. 4A, the SC-MIMO-based mapping scheme of the first example 400 maps a first code block 0 (e.g., CB0 shown with a light dotted pattern) and a second code block 1 (e.g., CB1 shown with a cross-hatch pattern) across the four layers based at least in part on a structured dependency between the three layer groups. For instance, CB0) is partitioned into four code block partitions and mapped across the three layer groups based at least in part on a first structured dependency 408 (e.g., between the first layer group 402 and the second layer group 404) and a second structured dependency 410 (e.g., between the second layer group 404 and the third layer group 406). In a similar manner as described with regard to FIG. 3, a layer-group-based structured dependency may result in code block partitions from different independent code blocks being transmitted simultaneously via different layers, such as a third code block partition of the first code block 0 (shown as CB0 Partition 2 in Layer 2) being simultaneously transmitted as a first code block partition and a second code block partition of the second code block 1 (shown as CB1 Partition 0 in Layer 0 and CB1 Partition 1 in Layer 1).

Alternatively, or additionally, code block partitions of a same code block that are mapped to a same group layer may be mapped in a manner that results in the code block partitions being transmitted simultaneously via different layers of the layer group. To illustrate, a first code block partition of CB0 (e.g., CB0 Partition 0) and a second code block partition of CB0 (e.g., CB0 Partition 1) are each mapped to a respective layer of the first layer group 402, shown as Layer 0 and Layer 1, respectively, and are mapped in a manner that results in the first code block partition of a first code block 0 and the second code block partition of the first code block being transmitted simultaneously in the MIMO transmission.

The first example 400 also includes two interference-mitigating code blocks (shown as I-M CB0 in solid white and I-M CB1 in a heavy dotted pattern) based at least in part on the MIMO transmission being configured with three layer groups. In some aspects, for a MIMO transmission that is configured with L layer groups (L being a first integer that is greater than two), the SC-MIMO-based mapping scheme may include L−1 interference-mitigating code blocks. Alternatively, or additionally, for a MIMO transmission that includes N layers (N being a second integer that is greater than two), each interference-mitigating code block may be separated into N interference-mitigating code block partitions that are mapped across the L layer groups and/or the N layers. Thus, while the first example 400 maps two interference-mitigating code blocks, other examples may include more than two interference-mapping code blocks.

The mapping of the interference-mitigating code blocks may be complementary to the mapping of other code blocks in the MIMO transmission. For example, the first code block 0 (e.g., CB0) and the second code block 1 (e.g., CB1) generally follow an SC-MIMO mapping structure that is based at least in part on structured dependencies that may be layer-based (e.g., code block partitions of a same code block being mapped across different layers) and/or time-based (e.g., code block partitions of a same code block being transmitted at different times and/or with code block partitions for a different code block). In the first example 400, the mapping of the first code block 0 and the second code block 1 follows a diagonal pattern across the code block resources of the different layers. The mapping of the interference-mitigating code blocks, by way of multiple interference-mitigating code block partitions, may be complementary to the code block partitions such that the interference-mitigating code block partitions occupy the other code block resources of the MIMO layers. For instance, each layer of the MIMO transmission in the first example 400 includes four code block resources, totaling 16 code block resources. The first code block 0 and the second code block 1 are mapped to eight (8) of the 16 code block resources, and the interference-mitigating code block partitions are mapped to the remaining 8 code block resources.

A column of code block resources may collectively include a same code block resource in each respective set of code block resources of each layer of in a MIMO transmission. For example, a first code block resource in Layer 3 (e.g., that is mapped to I-M CB0 Partition 2), a first code block resource in Layer 2 (e.g., that is mapped to I-M CB0 Partition 1), a first code block resource in Layer 1 (e.g., that is mapped to CB0 Partition 1), and a first code block resource in Layer 0 (e.g., that is mapped to CB0 Partition 1) may be collectively be referred to as a first column of code block resources, as shown by reference number 412. As another example, a third code block resource in Layer 3 (e.g., that is mapped to CB0 Partition 3), a third code block resource in Layer 2 (e.g., that is mapped to CB1 Partition 2), a third code block resource in Layer 1 (e.g., that is mapped to I-M CB0 Partition 1), and a third code block resource in Layer 0 (e.g., that is mapped to I-M CB0 Partition 0) may be collectively be referred to as a second column of code block resources, as shown by reference number 414. In some aspects, a code block mapping scheme may specify that the interference-mitigating code block partitions of an interference-mitigating code block be mapped across two columns of code block resources. Alternatively, or additionally, the code block mapping scheme may specify that the respective two columns of code blocks used for each interference-mitigating code block be separated by a constant and/or uniform difference (e.g., time difference, frequency difference, and/or code block resource difference).

To illustrate, as shown by FIG. 4A, an entirety of interference-mitigating code partitions of a first interference-mitigating code block (e.g., I-M CB0) are mapped across the first column of code block resources shown by reference number 412 and the second column of code block resources as shown by reference number 414, and the two columns are separated by a first difference 414-1 that is shown as a code block resource difference and may be characterized as a time difference and/or a frequency difference. In a similar manner, a second interference-mitigating code block (e.g., I-M CB1) is mapped across two columns of code block resources that are separated by a second difference 414-2 that is uniform and/or a same code block resource difference as the first difference 414-1. Mapping an interference-mitigating code block across two columns of code block resources that are separated by a uniform difference may be generally represented as:

$$f : code {block}_{i} ↦ \{ {h}_{i} , {h}_{i} + δ \}$$

where code blockᵢ is an interference-mitigating code block that is separated into multiple interference-mitigating code block partitions, hᵢ is a first column of code block resources, hᵢ+δ is a second column of code block resources, and δ is a constant and/or uniform code block resource difference. In some aspects, the code block resource difference (e.g., δ) may be configured such that mapping an entirety of interference-mitigating code blocks in a MIMO transmission, such as the first interference-mitigating code block and the second interference-mitigating code block in the first example 400, positions each interference-mitigating code block (and/or each interference-mitigating code block partition) within a same OFDM symbol. Generally, decomposition of N layers into L layer groups (shown as N=L=3 in the first example 400) may be represented using the following notation:

$$N = {\sum }_{i} {s}_{i}$$

where sᵢ is the number of layers in i-th layer group (out of L). Using the notation for L layer groups, a mapping scheme for the interference-mitigating code block partitions of an interference-mitigating code block; across the two columns of code blocks may be represented as:

$$N - {\sum }_{j \leq i} {s}_{i} layers , for column {h}_{i} , and$$

$${\sum }_{j \leq i} {s}_{i} layers , for column {h}_{i} + δ$$

In some aspects, a receiver may simultaneously decode an interference-mitigating code block; and perform SIC in column i−1 to increase hardware utilization. That is, the receiver may decode a first interference-mitigating code block (e.g., in a first column of the code block resources) in parallel with performing successive interference cancellation using a second column of code block resources.

In the first example 400, the layer groups of a MIMO transmission are unequal and/or do not include a same quantity of layers. For instance, the first layer group 402 includes two layers, while the second layer group 404 and the third layer group 406 include one layer, respectively. However, the code block mapping scheme described with regard to the first example 400 may be used to map interference-mitigation code blocks across layer groups that are equal and/or include a same quantity of layers. To illustrate, the second example 430 shown by FIG. 4A illustrates the same code block mapping scheme used in the first example 400 for a MIMO transmission that includes layer groups of equal size. More particularly, a first layer group 432, a second layer group 434, and a third layer group 436 of the MIMO transmission each include a single layer. A first interference-mitigating code block is separated into N=3 interference-mitigating code block partitions, and the interference-mitigating code block partitions are mapped across the three layer groups (e.g., L=3) such that the first interference-mitigating code block is mapped across a first column 438 and a third column 440. In a similar manner, a second interference-mitigating code block is separated into N=3 interference-mitigating code block partitions and mapped across the three layer groups such that the second interference-mitigating code block is mapped across a second column 442 and a fourth column 444. The first column 438 and the third column 440 are separated by a code block resource difference (e.g., one code block resource), and the second column 442 and the fourth column 444 are separated by the same code block resource difference.

The first example 400 and the second example 430 are examples of a first SC-MIMO-based mapping scheme (also referred to as a first code block mapping scheme) that may be used for mapping code block partitions across layer groups that include unequal quantities of layers (e.g., as shown by the first example 400) or layer groups that include equal quantities of layers (e.g., as shown by the second example 430). The third example 460 that is shown by FIG. 4B is a second SC-MIMO-based mapping scheme, which may also be referred to as a second code block mapping scheme, that may be used for mapping code block partitions across layer groups that include equal quantities of layers.

The third example 460 includes a first layer group 462, a second layer group 464, and a third layer group 466 that each include a single layer, but in other examples, the layer groups may include more than one layer. In a similar manner as described with regard to the first example 400 and the second example 430, a quantity of layer groups included in a MIMO transmission may be based at least in part on a quantity of layers per transport block (e.g., a maximum number of possible layers per transport block by the transmitter), a maximum supported number of layers per layer group (e.g., by a receiver), or a combination of both.

Each layer is partitioned into code block resources in a similar manner as described with regard to FIG. 3. A first column of code block resources 468 is a set of first code block resources across the N layers. In a similar manner, a second column of code block resources 470 is a set of second code block resources across the N layers, a third column of code block resources 472 is a set of third code block resources across the N layers, and a fourth column of code block resources 474 is a set of fourth code block resources across the N layers.

In a similar manner as the first example 400 and the second example 430, the second mapping scheme includes partitioning at least two code blocks into multiple code block partitions, and mapping the multiple code block partitions based at least in part on an SC-MIMO-based mapping scheme. In the third example 460, the SC-MIMO-based mapping of a first code block 0 (e.g., CB0 Partition 0, CB0 Partition 1, and CB0 Partition 2) is shown by FIG. 4B through the use of a light dotted pattern and the SC-MIMO-based mapping of a second code block 1 (e.g., CB1 Partition 0, CB1 Partition 1, and CB1 Partition 2) is shown by FIG. 4B through the use of a cross-hatch pattern. In the third example 460, each code block is partitioned into N=3 code block partitions, and the N code block partitions are mapped across the L layer groups based at least in part on a structured dependency as described above.

The second code block mapping scheme also includes separating an interference-mitigating code block into N interference-mitigating code block partitions (shown by FIG. 4B as being N=3), and mapping the N interference-mitigating code block partitions across a first set of (L−1) layer groups of the L layer groups. For instance, as shown by FIG. 4B, a first portion of the interference-mitigating code block partitions are mapped across the third layer group 466 and the second layer group 464 in a respective first code block resource of Layer 2 and Layer 1, respectively, in the first column of code block resources 468. A second portion of the interference-mitigating code block partitions are mapped across the third layer group 466 in a second code block resource in the second column of code block resources 470.

Alternatively, or additionally, the second code block mapping scheme also includes separating a tail code block into N tail code block partitions (shown by FIG. 4B as being N=3), and mapping the N tail code block partitions across a second set of (L−1) layer groups of the L layer groups, which are shown in FIG. 4B through the use of vertical stripes. “Tail code block” denotes a code block positioned at the end of a MIMO transmission to occupy code block resources that are not assigned an interference-mitigating code block partition and/or a code block partition that is mapped via an SC-MIMO-based mapping scheme. A tail code block may be transmitted using commensurate transmission parameters as a code block that is mapped via an SC-MIMO-based mapping scheme. As shown by FIG. 4B, a first portion of the N tail code block partitions are mapped across the first layer group 462 in a third code block resource of Layer 0 in the third column of code block resources 472, and a second portion of the tail code block partitions are mapped across the first layer group 462 and a second layer group 464 in a fourth code block resource of Layer 0 and Layer 1, respectively, in the second fourth of code block resources 474. The mapping of the tail code block partitions may be complementary to the mapping of the interference-mitigating code block partitions insofar as the tail code block partitions are mapped in a reverse pattern relative to the interference-mitigating code block partitions (or in complementary layer groups) such that each layer group includes a same quantity of tail code block partitions, interference-mitigating code block partitions, or combined tail code block partitions and interference-mitigating code block partitions. To illustrate, the first layer group 462 includes two tail block partitions, the second layer group 464 includes a tail block partition and an interference-mitigating code block partition (totaling two code block partitions), and the third layer group 466 includes two interference-mitigating code block partitions.

A transmitter may dynamically switch between using the first code block mapping scheme (e.g., a first SC-MIMO-based mapping scheme) described with regard to the first example 400 and the second example 430 to using the second code block mapping scheme (e.g., a second SC-MIMO-based mapping scheme) described with regard to the third example 460. For instance, the transmitter may compute and/or receive a measurement metric that indicates to switch from using the first code block mapping scheme to using the second code block mapping scheme (or vice versa). For instance, the transmitter may compute and/or receive a CSI metric that indicates that channel conditions have changed (e.g., the CSI metric satisfies a change threshold) by a degree that indicates that using a different mapping scheme may increase a robustness of transmissions by reducing recovery errors. To illustrate, the second code block mapping scheme described with regard to the third example 460 maps the interference-mitigating code block and the tail code block to the layers, and subsequently channels, that are linked to the lowest singular value (e.g., weaker channels). Accordingly, in fully orthogonal channel conditions (which may be indirectly indicated via a CSI metric), the transmitter may determine to switch from using the second code block mapping scheme to using the first code block mapping scheme to increase the robustness of a MIMO transmission, resulting in reduced recovery errors.

Using two or more interference-mitigating code blocks across more than two layers of a MIMO transmission enables a transmitter to use an SC-MIMO-based mapping scheme that includes structural dependency for MIMO transmissions that have more than two MIMO layers and/or across more than two layer groups. Alternatively, or additionally, using an SC-MIMO-based mapping scheme that uses a structural dependency for a MIMO transmission that includes more than two layers and/or more than two layer groups enables a receiver to use SIC in data recovery for the MIMO transmission and, consequently, reduce recovery errors at the receiver. Reducing recovery errors at the receiver for a MIMO transmission with more than two layers and/or more than two layer groups may result in increased data throughput and/or reduced data transfer latencies.

As indicated above, FIGS. 4A and 4B are provided as examples. Other examples may differ from what is described with regard to FIGS. 4A and 4B.

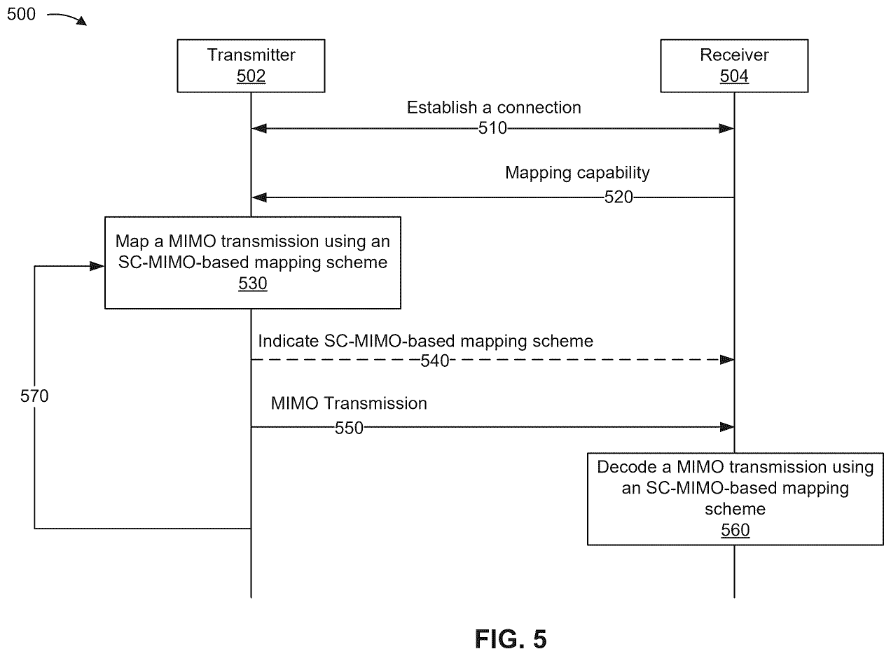

FIG. 5 is a diagram illustrating an example 500 of a wireless communication process between a transmitter 502 (e.g., a network node 110 or a UE 120) and a receiver 504 (e.g., a UE 120 or a network node 110), in accordance with the present disclosure. The transmitter 502 may transmit and/or receive communications with the receiver 504, and the receiver 504 may transmit and/or receive communications with the transmitter 502. In the example 500, the transmitter 502 is a first wireless communication device that performs SC-MIMO-based mapping for MIMO transmissions that include more than two layers (or more than two layer groups) as described with regard to FIGS. 4A and 4B, and the receiver is a second wireless communication device that performs decoding based at least in part on the SC-MIMO-based mapping as described with regard to FIGS. 4A and 4B. However, the transmitter 502 may also include SC-MIMO-based decoding functionality as described with regard to the receiver 504, and/or the receiver 504 may include SC-MIMO-based mapping functionality as described with regard to the transmitter 502.

As shown by reference number 510, a transmitter 502 and a receiver 504 may establish a connection. To illustrate, the receiver 504 may be a UE 120 that powers up in a cell coverage area provided by a network node 110 that operates as the transmitter 502, and the receiver 504 and the transmitter 502 may perform one or more procedures (e.g., a random access channel (RACH) procedure and/or an RRC procedure) to establish a wireless connection. As another example, the receiver 504 (e.g., as a UE 120) may move into the cell coverage area provided by the transmitter 502 (e.g., as a network node 110) and may perform a handover from a source network node to the transmitter 502. Alternatively, or additionally, the transmitter 502 and the receiver 504 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the transmitter 502 may request, via RRC signaling, capability information and/or the receiver 504 may transmit, via RRC signaling, the capability information. As part of communicating via the connection, the transmitter 502 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the transmitter 502 may transmit the configuration information via Layer 3 signaling at a first point in time associated with the receiver 504 being tolerant of communication delays, and the transmitter 502 may transmit an activation of the configuration via Layer 2 signaling and/or Layer 1 signaling at a second point in time associated with the receiver 504 being less tolerant to communication delays.

As shown by reference number 520, the receiver 504 may transmit, and the transmitter 502 may receive, an indication of a mapping capability. For instance, the receiver 504 may indicate support for an SC-MIMO-based mapping scheme for MIMO transmissions that include more than two layers or more than two layer groups, such as the first code block mapping scheme described with regard to FIG. 4A and the second code block mapping scheme described with regard to FIG. 4B.

For clarity, FIG. 5 illustrates the receiver 504 transmitting the indication of the mapping capability in a separate transaction than establishing a connection with the transmitter 502. However, in some aspects, the receiver 504 may transmit the indication of the mapping capability as part of establishing a connection with the receiver 504.

As shown by reference number 530, the transmitter 502 may map a MIMO transmission using an SC-MIMO-based mapping scheme. As one example, the transmitter 502 may map two or more code blocks across N layers of a MIMO transmission based at least in part on a first code block mapping scheme as described with regard to FIG. 4A or a second code block mapping scheme as described with regard to FIG. 4B, and the first code block mapping scheme and the second code block mapping scheme may be based at least in part on an SC-MIMO-based mapping scheme. For instance, in mapping the code blocks across the N layers of the MIMO transmission (for the first code block mapping scheme or the second code block mapping scheme), the transmitter may separate each code block into N code block partitions and may map the N code block partitions across the N layers such that each layer of the N layers is assigned a respective code block partition. Alternatively, or additionally, the transmitter 502 may map the N code block partition of each code block based at least in part on the N layers being separated into L layer groups. In some aspects, the L layer groups may be unequal such that the layer groups include unequal quantities of layers. In other aspects, the L layer groups may be equal such that each layer group includes a same quantity of layers.

Based at least in part on using the first code block mapping scheme, the transmitter may map two or more interference-mitigating code blocks across the N layers of the MIMO transmission, such as by separating each interference-mitigating code block into N interference-mitigating code block partitions and assigning each layer of the N layers a respective interference-mitigating code block partition. In some cases, the transmitter 502 may map the interference-mitigating code blocks using a complementary pattern to the mapping of the code blocks as described with regard to FIG. 4A. A quantity or number of interference-mitigating code blocks that are mapped by the transmitter 502 may be based at least in part on a quantity or number of layer groups. For instance, the transmitter 502 may map one less than L (e.g., L−1) interference-mitigating code blocks across the N layers of the MIMO transmission. Alternatively, or additionally, a quantity or number of layer groups may be based at least in part on a quantity or number of layers per transport block that are supported by the transmitter, a maximum supported number of layers per layer group supported by the receiver 504, or a combination of the two.

As described above, each layer of the N layers may be partitioned into a respective set of code block resources such that a column of code block resources is, collectively, a same code block resource of each layer of the N layers (e.g., in the respective set of code block resources for the layer). Based at least in part on using the first code block mapping scheme, the transmitter 502 may map each interference-mitigating code block, via the N interference-mitigating code block partitions, across two columns of code block resources. Each interference-mitigating code block may be mapped to a respective set of two columns of code block resources, and each set of two columns may be separated uniformly by a same code block resource difference (e.g., a same time partition difference and/or a same frequency partition difference). In some cases, the code block resource difference may be configured such that mapping the interference-mitigating code blocks results in the transmitter 502 positioning each interference-mitigating code block within a same orthogonal frequency division multiplexing symbol. Alternatively, or additionally, the transmitter 502 may map each interference-mitigating code block partition across the two columns of code block resources based at least in part on the L layer groups, such as by positioning interference-mitigating code block partitions within, for each layer in a layer group, a same respective code block resource of the layer.

Based at least in part on using the second code block mapping scheme, the transmitter 502 may map an interference-mitigating code block across a first set of (L−1) layer groups as described with regard to FIG. 4B. For instance, the transmitter may separate the interference-mitigating code block into N interference-mitigating code block partitions that are mapped across the first set of (L−1) layer groups. Alternatively, or additionally, the transmitter may map a tail code block across a second set of (L−1) layer groups by separating the tail code block into N tail code block partitions, and mapping the N tail code block partitions across the second set of (L−1) layer groups. The transmitter 502 may map the tail code block in a complementary manner to the mapping of the interference-mitigating code block.

As described above, each layer of the N layers may be partitioned into a respective set of time-frequency resources that, collectively for the entire MIMO transmission, form a plurality of time-frequency resources. Accordingly, in mapping the code block(s), interference-mitigating code block(s), and tail code block(s) across the N layers, the transmitter 502 may map a respective partition of a code block, an interference-mitigating code block, or tail code block to one or more time-frequency resources of the plurality of time-frequency resources.

As shown by reference number 540, the transmitter 502 may transmit, and the receiver 504 may receive, an indication of the SC-MIMO-based mapping scheme. For example, the transmitter 502 may select the first code block mapping scheme or the second code block mapping scheme based at least in part on a measurement metric, and may transmit an indication of the selected mapping scheme using Layer 1 signaling, Layer 2 signaling, Layer 3 signaling, or any combination thereof. While FIG. 5 illustrates the transmitter 502 transmitting the indication of the SC-MIMO-based mapping scheme separately from transmitting a MIMO transmission as described with regard to reference number 550, the transmitter 502 may transmit the indication of the SC-MIMO-based mapping scheme in the MIMO transmission or as part of the MIMO transmission.

As shown by reference number 550, the transmitter 502 may transmit, and the receiver 504 may receive, the MIMO transmission. For instance, the transmitter 502 may transmit the separate layers based at least in part on spatial multiplexing as described above. The MIMO transmission may carry a single code word (e.g., an NR single CW0) that is partitioned into multiple code blocks that are mapped as described with regard to reference number 530.

As shown by reference number 560, the receiver 504 may decode the MIMO transmission using an SC-MIMO-based mapping scheme, such as an SC-MIMO-based mapping scheme that is indicated by the transmitter 502. In some aspects, the MIMO transmission includes N layers (e.g., N being two) that carry two or more code blocks. The MIMO transmission received and decoded by the receiver 504 may be configured in any manner as described with regard to reference number 530.

Based at least in part on the MIMO transmission being mapped using the first code block mapping scheme, the MIMO transmission may include two or more interference-mitigating code blocks, and the receiver may decode the MIMO transmission based at least in part on a first mapping of the two or more code blocks across the N layers of the MIMO transmission that use an SC-MIMO-based mapping scheme and a second mapping of the interference-mitigating code blocks across the N layers of the MIMO transmission in a manner that is complementary to the first mapping of the two or more code blocks.

The N layers of the MIMO transmission may be separated into L layer groups. Based at least in part on the MIMO transmission being mapped using the second code block mapping scheme, the MIMO transmission may include an interference-mitigating code block that is mapped across a first set of (L−1) layer groups using N interference-mitigating code block partitions and a tail code block that is mapped across a second set of (L−1) layer groups using N tail code block partitions. The mapping of the tail code block may be complementary to the mapping of the interference-mitigating code block.

The receiver 504 may use SIC to decode at least some of the MIMO transmission. In some cases, the receiver 504 may decode a first interference-mitigating code block of the code block resources in parallel with performing SIC using a second column of code block resources.

As shown by reference number 570, the transmitter 502 and the receiver 504 may iteratively map a MIMO transmission using an SC-MIMO-based mapping scheme, transmit an indication of the SC-MIMO-based mapping scheme, transmit the (mapped) MIMO transmission, and decode the MIMO transmission using the SC-MIMO based mapping scheme. In some cases, as part of the iterative process, the transmitter 502 may compute or receive a measurement metric that indicates to switch from the first code block mapping scheme to the second code block mapping scheme (or vice versa). Accordingly, as part of the iterative process, the transmitter 502 may switch from using the first code block mapping scheme to the second code block mapping scheme (or vice versa).

Using two or more interference-mitigating code blocks across more than two layers of a MIMO transmission enables a transmitter to use an SC-MIMO-based mapping scheme that includes structural dependency for MIMO transmissions that have more than two MIMO layers and/or more than two layer groups. Alternatively, or additionally, using an SC-MIMO-based mapping scheme that uses a structural dependency for a MIMO transmission that includes more than two layers and/or more than two layer groups enables a receiver to use SIC in data recovery for the MIMO transmission and, consequently, reduce recovery errors at the receiver. Reducing recovery errors at the receiver for a MIMO transmission with more than two layers and/or more than two layer groups may result in increased data throughput and/or reduced data transfer latencies.

As indicated above, FIG. 5 is provided as an example. Other examples may differ from what is described with regard to FIG. 5.

FIG. 6 is a diagram illustrating an example process 600 performed, for example, at a transmitter or an apparatus of a transmitter, in accordance with the present disclosure. Example process 600 is an example where the apparatus or the transmitter (e.g., a UE 120 or a network node 110) performs operations associated with interference-mitigating code block mapping across more than two layers of a MIMO transmission using SC-MIMO.

As shown in FIG. 6, in some aspects, process 600 may include mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two (block 610). For example, the transmitter (e.g., using communication manager 1006, depicted in FIG. 10 as a UE 120 and using communication manager 1106, depicted in FIG. 11 as a network node 110) may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, as described above.

As further shown in FIG. 6, in some aspects, process 600 may include mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks (block 620). For example, the transmitter (e.g., using communication manager 1006, depicted in FIG. 10 as a UE 120 and using communication manager 1106, depicted in FIG. 11 as a network node 110) may map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks, as described above.

As further shown in FIG. 6, in some aspects, process 600 may include transmitting the MIMO transmission based at least in part on the mapping of the two or more code blocks and the mapping of the two or more interference-mitigating code blocks (block 630). For example, the transmitter (e.g., using transmission component 1004 and/or using communication manager 1006, depicted in FIG. 10 as a UE 120 and using transmission component 1104 and/or communication manager 1106, depicted in FIG. 11 as a network node 110) may transmit the MIMO transmission based at least in part on the mapping of the two or more code blocks and the mapping of the two or more interference-mitigating code blocks, as described above.

Process 600 may include additional aspects, such as any single aspect or any combination of aspects described below and/or in connection with one or more other processes described elsewhere herein.

In a first aspect, N is a first integer and the N layers are organized into L layer groups, L being a second integer, and a quantity of the two or more interference-mitigating code blocks that are mapped across the N layers of the MIMO transmission is one less than L.

In a second aspect, mapping the two or more interference-mitigating code blocks across the N layers of the MIMO transmission is based at least in part on the L layer groups.

In a third aspect, the quantity of the two or more interference-mitigating code blocks is a first quantity, and a value of L for the L layer groups is based at least in part on at least one of a second quantity of layers per transport block, or a maximum supported number of layers per layer group.

In a fourth aspect, at least one layer group of the L layer groups includes at least two layers of the N layers.

In a fifth aspect, each layer group of the L layer groups includes a same quantity of layers from the N layers.

In a sixth aspect, each layer of the N layers is partitioned into a respective set of time-frequency resources that, collectively, form a plurality of time-frequency resources, and mapping of the two or more code blocks across the N layers includes mapping, for each code block of the two or more code blocks, each code block partition of the N code block partitions to a time-frequency resource of the plurality of time-frequency resources.

In a seventh aspect, each layer of the N layers is partitioned into a respective set of code block resources, a column of code block resources is, collectively, a same code block resource in each respective set of code block resources of each layer of the N layers, and mapping of the two or more interference-mitigating code blocks across the N layers includes mapping, for each interference-mitigating code block of the two or more interference-mitigating code blocks, the N interference-mitigating code block partitions across two columns of code block resources.

In an eighth aspect, a first interference-mitigating code block of the two or more interference-mitigating code blocks is mapped to a first column of code block resources and a second column of code blocks that are separated by a code block resource difference, and a second interference-mitigating code block of the two or more interference-mitigating code blocks is mapped to a third column of code block resources and a fourth column of code block resources that are separated by the code block resource difference.

In a ninth aspect, the code block resource difference is configured such that mapping the two or more interference-mitigating code blocks positions each interference-mitigating code block of the two or more interference-mitigating code blocks within a same orthogonal frequency division multiplexing symbol.

In a tenth aspect, N is a first integer and the N layers are organized into L layer groups, L being a second integer, and mapping, for each interference-mitigating code block of the two or more interference-mitigating code blocks, the N interference-mitigating code block partitions across the two columns of code block resources is based at least in part on the L layer groups.

In an eleventh aspect, mapping the two or more code blocks across the N layers of the MIMO transmission, and mapping the two or more interference-mitigating code blocks across the N layers of the MIMO transmission, are collectively performed based at least in part on a first SC MIMO-based mapping scheme, and process 600 includes receiving a measurement metric that indicates to switch from the first SC MIMO-based mapping scheme to a second SC MIMO-based mapping scheme, and switching from using the first SC MIMO-based mapping scheme to using the second SC MIMO-based mapping scheme.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a receiver or an apparatus of a receiver, in accordance with the present disclosure. Example process 700 is an example where the apparatus or the receiver (e.g., a UE 120 or a network node 110) performs operations associated with interference-mitigating code block mapping across more than two layers of a MIMO transmission using SC-MIMO.

As shown in FIG. 7, in some aspects, process 700 may include receiving a MIMO transmission that includes N layers, N being an integer that is greater than two, the MIMO transmission including two or more code blocks and two or more interference-mitigating code blocks (block 710). For example, the receiver (e.g., using reception component 1002 and/or communication manager 1006, depicted in FIG. 10, as a UE 120 and using reception component 1102 and/or communication manager 1106, depicted in FIG. 11, as a network node 110) may receive a MIMO transmission that includes N layers, N being an integer that is greater than two, the MIMO transmission including two or more code blocks and two or more interference-mitigating code blocks, as described above.

As further shown in FIG. 7, in some aspects, process 700 may include decoding the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks (block 720). For example, the receiver (e.g., using the communication manager 1006, depicted in FIG. 10, as a UE 120 and using the communication manager 1106, depicted in FIG. 11, as a network node 110) may decode the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on an SC-MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks, as described above.

Process 700 may include additional aspects, such as any single aspect or any combination of aspects described below and/or in connection with one or more other processes described elsewhere herein.

In a first aspect, N is a first integer and the N layers are organized into L layer groups, L being a second integer, and a quantity of the two or more interference-mitigating code blocks that are mapped across the N layers of the MIMO transmission is one less than L.

In a second aspect, the second mapping of the two or more interference-mitigating code blocks across the N layers of the MIMO transmission is based at least in part on the L layer groups.

In a third aspect, the quantity of the two or more interference-mitigating code blocks is a first quantity, and a value of Z for the L layer groups is based at least in part on at least one of a second quantity of layers per transport block, or a maximum supported number of layers per layer group.

In a fourth aspect, at least one layer group of the L layer groups includes at least two layers of the N layers.

In a fifth aspect, each layer of the N layers is partitioned into a respective set of time-frequence resources that, collectively, form a plurality of time-frequency resources, and the first mapping of the two or more code blocks across the N layers is based at least in part on, for each code block of the two or more code blocks, each code block partition of the N code block partitions being mapped to a time-frequency resource of the plurality of time-frequency resources.

In a sixth aspect, each layer of the N layers is partitioned into a respective set of code block resources, a column of code block resources is, collectively, a same code block resource in each respective set of code block resources of each layer of the N layers, and the second mapping of the two or more interference-mitigating code blocks across the N layers is based at least in part on, for each interference-mitigating code block of the two or more interference-mitigating code blocks, the N interference-mitigating code block partitions being mapped across two columns of code block resources.

In a seventh aspect, the second mapping of the two or more interference-mitigating code blocks is based at least in part on a first interference-mitigating code block of the two or more interference-mitigating code blocks being mapped to a first column of code block resources and a second column of code block resources that are separated by a code block resource difference, and a second interference-mitigating code block of the two or more interference-mitigating code blocks being mapped to a third column of code block resources and a fourth column of code block resources that are separated by the code block resource difference.

In an eighth aspect, the code block resource difference is configured such that mapping the two or more interference-mitigating code blocks positions each interference-mitigating code block of the two or more interference-mitigating code blocks within a same orthogonal frequency division multiplexing symbol.

In a ninth aspect, N is a first integer and the N layers are organized into L layer groups, L being a second integer, and the second mapping is based at least in part on, for each interference-mitigating code block of the two or more interference-mitigating code blocks, the N interference-mitigating code block partitions being mapped across the two columns of code block resources based at least in part on the L layer groups.

In a tenth aspect, decoding the MIMO transmission includes decoding a first interference-mitigating code block of the code block resources in parallel with performing successive interference cancellation using a second column of code block resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a transmitter or an apparatus of a transmitter, in accordance with the present disclosure. Example process 800 is an example where the apparatus or the transmitter (e.g., a UE 120 or a network node 110) performs operations associated with interference-mitigating code block mapping across more than two layers of a MIMO transmission using SC-MIMO.

As shown in FIG. 8, in some aspects, process 800 may include mapping two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, the N layers being separated into L layer groups of equal size, L being a second integer (block 810). For example, the transmitter e.g., using communication manager 1006, depicted in FIG. 10 as a UE 120 and using communication manager 1106, depicted in FIG. 11 as a network node 110) may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two, the N layers being separated into L layer groups of equal size, L being a second integer, as described above.

As further shown in FIG. 8, in some aspects, process 800 may include mapping an interference-mitigating code block across a first set of (L−1) layer groups based at least in part on the interference-mitigating code block being separated into N interference-mitigating code block partitions (block 820). For example, the transmitter (e.g., using communication manager 1006, depicted in FIG. 10 as a UE 120 and using communication manager 1106, depicted in FIG. 11 as a network node 110) may map an interference-mitigating code block across a first set of (L−1) layer groups based at least in part on the interference-mitigating code block being separated into N interference-mitigating code block partitions, as described above.

As further shown in FIG. 8, in some aspects, process 800 may include mapping a tail code block across a second set of (L−1) layer groups based at least in part on the tail code block being separated into N tail code block partitions, the mapping of the tail code block being complementary to the mapping of the interference-mitigating code block (block 830). For example, the transmitter (e.g., using communication manager 1006, depicted in FIG. 10 as a UE 120 and using communication manager 1106, depicted in FIG. 11 as a network node 110) may map a tail code block across a second set of (L−1) layer groups based at least in part on the tail code block being separated into N tail code block partitions, the mapping of the tail code block being complementary to the mapping of the interference-mitigating code block, as described above.

As further shown in FIG. 8, in some aspects, process 800 may include transmitting the MIMO transmission based at least in part on the mapping of the two or more code blocks, the mapping of the interference-mitigating code block, and the mapping of the tail code block (block 840). For example, the transmitter (e.g., using communication manager 1006, depicted in FIG. 10 as a UE 120 and using communication manager 1106, depicted in FIG. 11 as a network node 110) may transmit the MIMO transmission based at least in part on the mapping of the two or more code blocks, the mapping of the interference-mitigating code block, and the mapping of the tail code block, as described above.

Process 800 may include additional aspects, such as any single aspect or any combination of aspects described below and/or in connection with one or more other processes described elsewhere herein.

In a first aspect, mapping the two or more code blocks across the N layers of the MIMO transmission, mapping the interference-mitigating code block across the first set of (L−1) layer groups of the L layer groups, and mapping the tail code block across the second set of (L−1) layer groups of the L layer groups are, collectively, performed based at least in part on a second SC-MIMO-based mapping scheme, and process 800 includes receiving a measurement metric that indicates to switch from the second SC MIMO-based mapping scheme to a first SC MIMO-based mapping scheme, and switching from using the second SC MIMO-based mapping scheme to using the first SC MIMO-based mapping scheme.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a receiver or an apparatus of a receiver, in accordance with the present disclosure. Example process 900 is an example where the apparatus or the receiver (e.g., a UE 120 or a network node 110) performs operations associated with interference-mitigating code block mapping across more than two layers of a MIMO transmission using SC-MIMO.

As shown in FIG. 9, in some aspects, process 900 may include receiving a MIMO transmission that includes N layers, N being an integer that is greater than two, the MIMO transmission including two or more code blocks, an interference-mitigating code block, and a tail code block (block 910). For example, the receiver (e.g., using reception component 1002 and/or communication manager 1006, depicted in FIG. 10, as a UE 120 and using reception component 1102 and/or communication manager 1106, depicted in FIG. 11, as a network node 110) may receive a MIMO transmission that includes N layers, N being an integer that is greater than two, the MIMO transmission including two or more code blocks, an interference-mitigating code block, and a tail code block, as described above.

As further shown in FIG. 9, in some aspects, process 900 may include decoding the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block (block 920). For example, the receiver (e.g., using a communication manager 1006, depicted in FIG. 10, as a UE 120 and using a communication manager 1106, depicted in FIG. 11, as a network node 110) may decode the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block, as described above.

Process 900 may include additional aspects, such as any single aspect or any combination of aspects described below and/or in connection with one or more other processes described elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE 120, or a UE 120 may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 4A-5. Additionally, or alternatively, the apparatus 1000 may be configured to perform one or more processes described herein, such as process 600 of FIG. 6, process 700 of FIG. 7, process 800 of FIG. 8, process 900 of FIG. 9, or a combination thereof. In some aspects, the apparatus 1000 and/or one or more components shown in FIG. 10 may include one or more components of the UE 120 described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the transmitter described above in connection with FIG. 1, such as a radio, one or more RF chains, one or more transceivers, or one or more modems, each of which may in turn be coupled with one or more antennas of the transmitter.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

Based at least in part on the apparatus 1000 being a transmitter, the communication manager 1006 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two. The communication manager 1006 may map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks. The transmission component 1004 may transmit the MIMO transmission based at least in part on the mapping of the two or more code blocks and the mapping of the two or more interference-mitigating code blocks.

Alternatively, or additionally, and based at least in part on the apparatus 1000 being a transmitter, the communication manager 1006 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being a first integer greater than two, the N layers being separated into L layer groups of equal size, L being a second integer. The communication manager 1006 may map an interference-mitigating code block across a first set of (L−1) layer groups based at least in part on the interference-mitigating code block being separated into N interference-mitigating code block partitions. The communication manager 1006 may map a tail code block across a second set of (L−1) layer groups based at least in part on the tail code block being separated into N tail code block partitions, the mapping of the tail code block being complementary to the mapping of the interference-mitigating code block. The transmission component 1004 may transmit the MIMO transmission based at least in part on the mapping of the two or more code blocks, the mapping of the interference-mitigating code block, and the mapping of the tail code block.

Based at least in part on the apparatus 1000 being a receiver, the reception component 1002 may receive a MIMO transmission that includes N layers, N being an integer that is greater than two, and the MIMO transmission may include two or more code blocks and two or more interference-mitigating code blocks. The communication manager 1006 may decode the MIMO transmission based at least in part on a first mapping of the two or more code blocks across the N layers of the MIMO transmission, where each code block of the two or more code blocks is separated into N code block partitions such that each layer of the N layers includes a respective code block partition of the N code block partitions. The communication manager 1006 may decode the MIMO transmission based at least in part on the first mapping of the two or more code blocks being an SC-MIMO-based mapping scheme. The communication manager 1006 may decode the MIMO transmission based at least in part on a second mapping of the two or more interference-mitigating code blocks across the N layers of the MIMO transmission and each interference-mitigating code block being separated into N interference-mitigating code block partitions such that each layer of the N layers includes a respective interference-mitigating code block partition of the N code block partitions. The second mapping of the two or more interference-mitigating code blocks may be complementary to the first mapping of the two or more code blocks.

Alternatively, or additionally, and based at least in part on the apparatus being a receiver, the reception component 1002 may receive a MIMO transmission that includes N layers, N being an integer that is greater than two. The MIMO transmission may include two or more code blocks, an interference-mitigating code block, and a tail code block. The communication manager 1006 may decode the MIMO transmission based at least in part on a first mapping of the two or more code blocks across the N layers of the MIMO transmission, each code block of the two or more code blocks being separated into N code block partitions such that each layer of the N layers is assigned a respective code block partition of the N code block partitions. In some aspects, the mapping of the two or more code blocks being based at least in part on an SC-MIMO-based mapping scheme and the N layers are separated into L layer groups of equal size (L being a second integer). The communication manager 1006 may decode the MIMO transmission based at least in part on a second mapping of the interference-mitigating code block across a first set of (L−1) layer groups and based at least in part on the interference-mitigating code block being separated into N interference-mitigating code block partitions. The communication manager 1006 may decode the MIMO transmission based at least in part on a third mapping of the tail code block across a second set of (L−1) layer groups and the tail code block being separated into N tail code block partitions. The communication manager 1006 may decode the MIMO transmission based at least in part on the mapping of the tail code block being complementary to the mapping of the interference-mitigating code block.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node 110, or a network node 110 may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 4A-5. Additionally, or alternatively, the apparatus 1100 may be configured to perform one or more processes described herein, such as process 600 of FIG. 6, process 700 of FIG. 7, process 800 of FIG. 8, process 900 of FIG. 9, or a combination thereof. In some aspects, the apparatus 1100 and/or one or more components shown in FIG. 11 may include one or more components of the receiver described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the receiver described above in connection with FIG. 1, such as a radio, one or more RF chains, one or more transceivers, or one or more modems, each of which may in turn be coupled with one or more antennas of the receiver.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the receiver described above in connection with FIG. 1, such as a radio, one or more RF chains, one or more transceivers, or one or more modems, each of which may in turn be coupled with one or more antennas of the receiver described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

Based at least in part on the apparatus 1100 being a transmitter, the communication manager 1106 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being an integer greater than two. The communication manager 1106 may map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks. The transmission component 1104 may transmit the MIMO transmission based at least in part on the mapping of the two or more code blocks and the mapping of the two or more interference-mitigating code blocks.

Alternatively, or additionally, and based at least in part on the apparatus 1100 being a transmitter, the communication manager 1106 may map two or more code blocks across N layers of a MIMO transmission, each code block of the two or more code blocks being separated into N code block partitions such that each layer of the N layers is assigned a respective code block partition of the N code block partitions, the mapping of the two or more code blocks being based at least in part on an SC-MIMO-based mapping scheme and N being a first integer greater than two, the N layers being separated into L layer groups of equal size, L being a second integer. The communication manager 1106 may map an interference-mitigating code block across a first set of (L−1) layer groups based at least in part on the interference-mitigating code block being separated into N interference-mitigating code block partitions. The communication manager 1106 may map a tail code block across a second set of (L−1) layer groups based at least in part on the tail code block being separated into N tail code block partitions, the mapping of the tail code block being complementary to the mapping of the interference-mitigating code block. The transmission component 1104 may transmit the MIMO transmission based at least in part on the mapping of the two or more code blocks, the mapping of the interference-mitigating code block, and the mapping of the tail code block.

Based at least in part on the apparatus 1100 being a receiver, the reception component 1102 may receive a MIMO transmission that includes N layers, N being an integer that is greater than two, and the MIMO transmission may include two or more code blocks and two or more interference-mitigating code blocks. The communication manager 1106 may decode the MIMO transmission based at least in part on a first mapping of the two or more code blocks across the N layers of the MIMO transmission, where each code block of the two or more code blocks is separated into N code block partitions such that each layer of the N layers includes a respective code block partition of the N code block partitions. The communication manager 1106 may decode the MIMO transmission based at least in part on the first mapping of the two or more code blocks being an SC-MIMO-based mapping scheme. The communication manager 1106 may decode the MIMO transmission based at least in part on a second mapping of the two or more interference-mitigating code blocks across the N layers of the MIMO transmission and each interference-mitigating code block being separated into N interference-mitigating code block partitions such that each layer of the N layers includes a respective interference-mitigating code block partition of the N code block partitions. The second mapping of the two or more interference-mitigating code blocks may be complementary to the first mapping of the two or more code blocks

Alternatively, or additionally, and based at least in part on the apparatus being a receiver, the reception component 1102 may receive a MIMO transmission that includes N layers, N being an integer that is greater than two. The MIMO transmission may include two or more code blocks, an interference-mitigating code block, and a tail code block. The communication manager 1106 may decode the MIMO transmission based at least in part on a first mapping of the two or more code blocks across the N layers of the MIMO transmission, each code block of the two or more code blocks being separated into N code block partitions such that each layer of the N layers is assigned a respective code block partition of the N code block partitions. In some aspects, the mapping of the two or more code blocks being based at least in part on an SC-MIMO-based mapping scheme and the N layers are separated into L layer groups of equal size (L being a second integer). The communication manager 1106 may decode the MIMO transmission based at least in part on a second mapping of the interference-mitigating code block across a first set of (L−1) layer groups and based at least in part on the interference-mitigating code block being separated into N interference-mitigating code block partitions. The communication manager 1106 may decode the MIMO transmission based at least in part on a third mapping of the tail code block across a second set of (L−1) layer groups and the tail code block being separated into N tail code block partitions. The communication manager 1106 may decode the MIMO transmission based at least in part on the mapping of the tail code block being complementary to the mapping of the interference-mitigating code block.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a transmitter, comprising: mapping two or more code blocks across N layers of a multiple-input, multiple-output (MIMO) transmission, each code block of the two or more code blocks being separated into N code block partitions such that each layer of the N layers is assigned a respective code block partition of the N code block partitions, the mapping of the two or more code blocks being based at least in part on a spatially-coupled (SC) MIMO-based mapping scheme and N being an integer greater than two; mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks; and transmitting the MIMO transmission based at least in part on the mapping of the two or more code blocks and the mapping of the two or more interference-mitigating code blocks.

Aspect 2: The method of Aspect 1, wherein Nis a first integer and the N layers are organized into L layer groups, L being a second integer, and wherein a quantity of the two or more interference-mitigating code blocks that are mapped across the N layers of the MIMO transmission is one less than L.

Aspect 3: The method of Aspect 2, wherein mapping the two or more interference-mitigating code blocks across the N layers of the MIMO transmission is based at least in part on the L layer groups.

Aspect 4: The method of any one of Aspects 2-3, wherein the quantity of the two or more interference-mitigating code blocks is a first quantity, and wherein a value of L for the L layer groups is based at least in part on at least one of: a second quantity of layers per transport block, or a maximum supported number of layers per layer group.

Aspect 5: The method of any one of Aspects 2-4, wherein at least one layer group of the L layer groups includes at least two layers of the N layers.

Aspect 6: The method of any one of Aspects 2-4, wherein each layer group of the L layer groups includes a same quantity of layers from the N layers.

Aspect 7: The method of any of Aspects 1-6, wherein each layer of the N layers is partitioned into a respective set of time-frequency resources that, collectively, form a plurality of time-frequency resources, and wherein the mapping of the two or more code blocks across the N layers comprises: mapping, for each code block of the two or more code blocks, each code block partition of the N code block partitions to a time-frequency resource of the plurality of time-frequency resources.

Aspect 8: The method of any of Aspects 1-7, wherein each layer of the N layers is partitioned into a respective set of code block resources, wherein a column of code block resources is, collectively, a same code block resource in each respective set of code block resources of each layer of the N layers, and wherein the mapping of the two or more interference-mitigating code blocks across the N layers comprises: mapping, for each interference-mitigating code block of the two or more interference-mitigating code blocks, the N interference-mitigating code block partitions across two columns of code block resources.

Aspect 9: The method of Aspect 8, wherein a first interference-mitigating code block of the two or more interference-mitigating code blocks is mapped to a first column of code block resources and a second column of code blocks, wherein the first column of code block resources and the second column of code block resources are separated by a code block resource difference, and wherein a second interference-mitigating code block of the two or more interference-mitigating code blocks is mapped to a third column of code block resources and a fourth column of code block resources, wherein the third column of code block resources and the fourth column of code block resources are separated by the code block resource difference.

Aspect 10: The method of Aspect 9, wherein the code block resource difference is configured such that mapping the two or more interference-mitigating code blocks positions each interference-mitigating code block of the two or more interference-mitigating code blocks within a same orthogonal frequency division multiplexing symbol.

Aspect 11: The method of Aspect 9, wherein Nis a first integer and the N layers are organized into L layer groups, L being a second integer, and wherein mapping, for each interference-mitigating code block of the two or more interference-mitigating code blocks, the N interference-mitigating code block partitions across the two columns of code block resources is based at least in part on the L layer groups.

Aspect 12: The method of any of Aspects 1-11, wherein mapping the two or more code blocks across the N layers of the MIMO transmission, and mapping the two or more interference-mitigating code blocks across the N layers of the MIMO transmission, are collectively performed based at least in part on a first SC MIMO-based mapping scheme, and wherein the method further comprises: receiving a measurement metric that indicates to switch from the first SC MIMO-based mapping scheme to a second SC MIMO-based mapping scheme; and switching from using the first SC MIMO-based mapping scheme to using the second SC MIMO-based mapping scheme.

Aspect 13: A method of wireless communication performed by a receiver, comprising: receiving a multiple-input, multiple-output (MIMO) transmission that includes N layers, N being an integer that is greater than two, the MIMO transmission including two or more code blocks and two or more interference-mitigating code blocks; and decoding the MIMO transmission based at least in part on: a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on a spatially-coupled (SC) MIMO-based mapping scheme, and a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

Aspect 14: The method of Aspect 13, wherein Nis a first integer and the N layers are organized into L layer groups, L being a second integer, and wherein a quantity of the two or more interference-mitigating code blocks that are mapped across the N layers of the MIMO transmission is one less than L.

Aspect 15: The method of Aspect 14, wherein the second mapping of the two or more interference-mitigating code blocks across the N layers of the MIMO transmission is based at least in part on the L layer groups.

Aspect 16: The method of Aspect 14, wherein the quantity of the two or more interference-mitigating code blocks is a first quantity, and wherein a value of L for the L layer groups is based at least in part on at least one of: a second quantity of layers per transport block, or a maximum supported number of layers per layer group.

Aspect 17: The method of Aspect 14, wherein at least one layer group of the L layer groups includes at least two layers of the N layers.

Aspect 18: The method of any of Aspects 13-17, wherein each layer of the N layers is partitioned into a respective set of time-frequence resources that, collectively, form a plurality of time-frequency resources, and wherein the first mapping of the two or more code blocks across the N layers is based at least in part on, for each code block of the two or more code blocks, each code block partition of the N code block partitions being mapped to a time-frequency resource of the plurality of time-frequency resources.

Aspect 19: The method of any of Aspects 13-18, wherein each layer of the N layers is partitioned into a respective set of code block resources, wherein a column of code block resources is, collectively, a same code block resource in each respective set of code block resources of each layer of the N layers, and wherein the second mapping of the two or more interference-mitigating code blocks across the N layers is based at least in part on, for each interference-mitigating code block of the two or more interference-mitigating code blocks, the N interference-mitigating code block partitions being mapped across two columns of code block resources.

Aspect 20: The method of Aspect 19, wherein the second mapping of the two or more interference-mitigating code blocks is based at least in part on: a first interference-mitigating code block of the two or more interference-mitigating code blocks being mapped to a first column of code block resources and a second column of code block resources, wherein the first column of code block resources and the second column of code block resources are separated by a code block resource difference, and a second interference-mitigating code block of the two or more interference-mitigating code blocks being mapped to a third column of code block resources and a fourth column of code block resources, wherein the third column of code block resources and the fourth column of code block resources are separated by the code block resource difference.

Aspect 21: The method of Aspect 20, wherein the code block resource difference is configured such that mapping the two or more interference-mitigating code blocks positions each interference-mitigating code block of the two or more interference-mitigating code blocks within a same orthogonal frequency division multiplexing symbol.

Aspect 22: The method of Aspect 19, wherein Nis a first integer and the N layers are organized into L layer groups, L being a second integer, and wherein the second mapping is based at least in part on, for each interference-mitigating code block of the two or more interference-mitigating code blocks, the N interference-mitigating code block partitions being mapped across the two columns of code block resources based at least in part on the L layer groups.

Aspect 23: The method of Aspect 19, wherein decoding the MIMO transmission comprises: decoding a first interference-mitigating code block of the code block resources in parallel with performing successive interference cancellation using a second column of code block resources.

Aspect 24: A method of wireless communication performed by a transmitter, comprising: mapping two or more code blocks across N layers of a multiple-input, multiple-output (MIMO) transmission, each code block of the two or more code blocks being separated into N code block partitions such that each layer of the N layers is assigned a respective code block partition of the N code block partitions, the mapping of the two or more code blocks being based at least in part on a spatially-coupled (SC) MIMO-based mapping scheme and N being an integer greater than two, the N layers being separated into L layer groups of equal size, L being a second integer; mapping an interference-mitigating code block across a first set of (L−1) layer groups based at least in part on the interference-mitigating code block being separated into N interference-mitigating code block partitions; mapping a tail code block across a second set of (L−1) layer groups based at least in part on the tail code block being separated into N tail code block partitions, the mapping of the tail code block being complementary to the mapping of the interference-mitigating code block; and transmitting the MIMO transmission based at least in part on the mapping of the two or more code blocks, the mapping of the interference-mitigating code block, and the mapping of the tail code block.

Aspect 25: The method of Aspect 24, wherein mapping the two or more code blocks across the N layers of the MIMO transmission, mapping the interference-mitigating code block across the first set of (L−1) layer groups of the L layer groups, and mapping the tail code block across the second set of (L−1) layer groups of the L layer groups are, collectively, performed based at least in part on a second SC-MIMO-based mapping scheme, and wherein the method further comprises: receiving a measurement metric that indicates to switch from the second SC MIMO-based mapping scheme to a first SC MIMO-based mapping scheme; and switching from using the second SC MIMO-based mapping scheme to using the first SC MIMO-based mapping scheme.

Aspect 26: A method of wireless communication performed by a receiver, comprising: receiving a multiple-input, multiple-output (MIMO) transmission that includes N layers, N being an integer that is greater than two, the MIMO transmission including two or more code blocks, an interference-mitigating code block, and a tail code block; and decoding the MIMO transmission based at least in part on: a first mapping of the two or more code blocks across the N layers of the MIMO transmission, each code block of the two or more code blocks being separated into N code block partitions such that each layer of the N layers is assigned a respective code block partition of the N code block partitions, the mapping of the two or more code blocks being based at least in part on a spatially-coupled (SC) MIMO-based mapping scheme, the N layers being separated into L layer groups of equal size, L being a second integer, a second mapping of the interference-mitigating code block across a first set of (L−1) layer groups based at least in part on the interference-mitigating code block being separated into N interference-mitigating code block partitions, and a third mapping of the tail code block across a second set of (L−1) layer groups based at least in part on the tail code block being separated into N tail code block partitions, the mapping of the tail code block being complementary to the mapping of the interference-mitigating code block.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.

Aspect 28: An apparatus for wireless communication at a device, the apparatus comprising one or more memories and one or more processors coupled to the one or more memories, the one or more processors configured to cause the device to perform the method of one or more of Aspects 1-12.

Aspect 29: An apparatus for wireless communication, the apparatus comprising at least one means for performing the method of one or more of Aspects 1-12.

Aspect 30: A non-transitory computer-readable medium storing code for wireless communication, the code comprising instructions executable by one or more processors to perform the method of one or more of Aspects 1-12.

Aspect 31: A non-transitory computer-readable medium storing a set of instructions for wireless communication, the set of instructions comprising one or more instructions that, when executed by one or more processors of a device, cause the device to perform the method of one or more of Aspects 1-12.

Aspect 32: A device for wireless communication, the device comprising a processing system that includes one or more processors and one or more memories coupled with the one or more processors, the processing system configured to cause the device to perform the method of one or more of Aspects 1-12.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-12.

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-23.

Aspect 35: An apparatus for wireless communication at a device, the apparatus comprising one or more memories and one or more processors coupled to the one or more memories, the one or more processors configured to cause the device to perform the method of one or more of Aspects 12-23.

Aspect 36: An apparatus for wireless communication, the apparatus comprising at least one means for performing the method of one or more of Aspects 12-23.

Aspect 37: A non-transitory computer-readable medium storing code for wireless communication, the code comprising instructions executable by one or more processors to perform the method of one or more of Aspects 12-23.

Aspect 38: A non-transitory computer-readable medium storing a set of instructions for wireless communication, the set of instructions comprising one or more instructions that, when executed by one or more processors of a device, cause the device to perform the method of one or more of Aspects 12-23.

Aspect 39: A device for wireless communication, the device comprising a processing system that includes one or more processors and one or more memories coupled with the one or more processors, the processing system configured to cause the device to perform the method of one or more of Aspects 12-23.

Aspect 40: An apparatus for wireless communication at a device, the apparatus comprising one or more memories and one or more processors coupled to the one or more memories, the one or more processors individually or collectively configured to cause the device to perform the method of one or more of Aspects 12-23.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 24-25.

Aspect 42: An apparatus for wireless communication at a device, the apparatus comprising one or more memories and one or more processors coupled to the one or more memories, the one or more processors configured to cause the device to perform the method of one or more of Aspects 24-25.

Aspect 43: An apparatus for wireless communication, the apparatus comprising at least one means for performing the method of one or more of Aspects 24-25.

Aspect 44: A non-transitory computer-readable medium storing code for wireless communication, the code comprising instructions executable by one or more processors to perform the method of one or more of Aspects 24-25.

Aspect 45: A non-transitory computer-readable medium storing a set of instructions for wireless communication, the set of instructions comprising one or more instructions that, when executed by one or more processors of a device, cause the device to perform the method of one or more of Aspects 24-25.

Aspect 46: A device for wireless communication, the device comprising a processing system that includes one or more processors and one or more memories coupled with the one or more processors, the processing system configured to cause the device to perform the method of one or more of Aspects 24-25.

Aspect 47: An apparatus for wireless communication at a device, the apparatus comprising one or more memories and one or more processors coupled to the one or more memories, the one or more processors individually or collectively configured to cause the device to perform the method of one or more of Aspects 24-25.

Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 26.

Aspect 49: An apparatus for wireless communication at a device, the apparatus comprising one or more memories and one or more processors coupled to the one or more memories, the one or more processors configured to cause the device to perform the method of one or more of Aspects 26.

Aspect 50: An apparatus for wireless communication, the apparatus comprising at least one means for performing the method of one or more of Aspects 26.

Aspect 51: A non-transitory computer-readable medium storing code for wireless communication, the code comprising instructions executable by one or more processors to perform the method of one or more of Aspects 26.

Aspect 52: A non-transitory computer-readable medium storing a set of instructions for wireless communication, the set of instructions comprising one or more instructions that, when executed by one or more processors of a device, cause the device to perform the method of one or more of Aspects 26.

Aspect 53: A device for wireless communication, the device comprising a processing system that includes one or more processors and one or more memories coupled with the one or more processors, the processing system configured to cause the device to perform the method of one or more of Aspects 26.

Aspect 54: An apparatus for wireless communication at a device, the apparatus comprising one or more memories and one or more processors coupled to the one or more memories, the one or more processors individually or collectively configured to cause the device to perform the method of one or more of Aspects 26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter, comprising:
a processing system that includes processor circuitry and code-storing memory circuitry, the processing system configured to cause the transmitter to:
map two or more code blocks across N layers of a multiple-input, multiple-output (MIMO) transmission, each code block of the two or more code blocks being separated into N code block partitions such that each layer of the N layers is assigned a respective code block partition of the N code block partitions, the processing system configured to cause the transmitter to map the two or more code blocks based at least in part on a spatially-coupled (SC)-MIMO-based mapping scheme, N being an integer greater than two;
map two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the processing system configured to cause the transmitter to map of the two or more interference-mitigating code blocks in a complementary manner to the two or more code blocks; and
transmit the MIMO transmission based at least in part on the two or more code blocks being mapped based at least in part on the SC-MIMO-based mapping scheme and the two or more interference-mitigating code blocks being mapped in the complementary manner.

2. The transmitter of claim 1, wherein N is a first integer and the N layers are organized into L layer groups, L being a second integer, and
wherein a quantity of the two or more interference-mitigating code blocks that are mapped across the N layers of the MIMO transmission is one less than L.

3. The transmitter of claim 2, wherein to map the two or more interference-mitigating code blocks across the N layers of the MIMO transmission, the processing system is configured to:
map the two or more interference-mitigating code blocks across the N layers of the MIMO transmission is based at least in part on the L layer groups.

4. The transmitter of claim 2, wherein the quantity of the two or more interference-mitigating code blocks is a first quantity, and
wherein a value of L for the L layer groups is based at least in part on at least one of:
a second quantity of layers per transport block, or
a maximum supported number of layers per layer group.

5. The transmitter of claim 1, wherein each layer of the N layers is partitioned into a respective set of time-frequency resources that, collectively, form a plurality of time-frequency resources, and
wherein to map the two or more code blocks across the N layers, the processing system is configured to:
map, for each code block of the two or more code blocks, each code block partition of the N code block partitions to a time-frequency resource of the plurality of time-frequency resources.

6. The transmitter of claim 1, wherein each layer of the N layers is partitioned into a respective set of code block resources,
wherein a column of code block resources is, collectively, a same code block resource in each respective set of code block resources of each layer of the N layers, and
wherein, to map the two or more interference-mitigating code blocks across the N layers, the processing system is configured to:
map, for each interference-mitigating code block of the two or more interference-mitigating code blocks, the N interference-mitigating code block partitions across two columns of code block resources.

7. The transmitter of claim 6, wherein a first interference-mitigating code block of the two or more interference-mitigating code blocks is mapped to a first column of code block resources and a second column of code blocks, wherein the first column of code block resources and the second column of code block resources are separated by a code block resource difference, and
wherein a second interference-mitigating code block of the two or more interference-mitigating code blocks is mapped to a third column of code block resources and a fourth column of code block resources, wherein the third column of code block resources and the fourth column of code block resources are separated by the code block resource difference.

8. The transmitter of claim 7, wherein the code block resource difference is configured such that the processing system is configured to position each interference-mitigating code block of the two or more interference-mitigating code blocks within a same orthogonal frequency division multiplexing symbol.

9. The transmitter of claim 1, wherein the processing system is configured cause the transmitter to map the two or more code blocks across the N layers of the MIMO transmission, and map the two or more interference-mitigating code blocks across the N layers of the MIMO transmission based at least in part on a first SC-MIMO-based mapping scheme, and
wherein the processing system is configured to cause the transmitter to:
receive a measurement metric that indicates to switch from the first SC MIMO-based mapping scheme to a second SC-MIMO-based mapping scheme; and
switch from using the first SC-MIMO-based mapping scheme to using the second SC-MIMO-based mapping scheme.

10. A receiver, comprising:
a processing system that includes processor circuitry and code-storing memory circuitry, the processing system configured to cause the receiver to:
receive a multiple-input, multiple-output (MIMO) transmission that includes N layers, N being an integer that is greater than two, the MIMO transmission including two or more code blocks and two or more interference-mitigating code blocks; and
decode the MIMO transmission based at least in part on:
a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on a spatially-coupled-MIMO-based mapping scheme, and
a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

11. The receiver of claim 10, wherein N is a first integer and the N layers are organized into L layer groups, L being a second integer, and
wherein a quantity of the two or more interference-mitigating code blocks that are mapped across the N layers of the MIMO transmission is one less than L.

12. The receiver of claim 11, wherein the second mapping of the two or more interference-mitigating code blocks across the N layers of the MIMO transmission is based at least in part on the L layer groups.

13. The receiver of claim 11, wherein the quantity of the two or more interference-mitigating code blocks is a first quantity, and
wherein a value of L for the L layer groups is based at least in part on at least one of:
a second quantity of layers per transport block, or
a maximum supported number of layers per layer group.

14. The receiver of claim 10, wherein each layer of the N layers is partitioned into a respective set of code block resources,
wherein a column of code block resources is, collectively, a same code block resource in each respective set of code block resources of each layer of the N layers, and
wherein the second mapping of the two or more interference-mitigating code blocks across the N layers is based at least in part on, for each interference-mitigating code block of the two or more interference-mitigating code blocks, the N interference-mitigating code block partitions being mapped across two columns of code block resources.

15. The receiver of claim 14, wherein the second mapping of the two or more interference-mitigating code blocks is based at least in part on:
a first interference-mitigating code block of the two or more interference-mitigating code blocks being mapped to a first column of code block resources and a second column of code block resources, wherein the first column of code block resources and the second column of code block resources are separated by a code block resource difference, and
a second interference-mitigating code block of the two or more interference-mitigating code blocks being mapped to a third column of code block resources and a fourth column of code block resources, wherein the third column of code block resources and the fourth column of code block resources are separated by the code block resource difference.

16. The receiver of claim 15, wherein the code block resource difference is configured such that each interference-mitigating code block of the two or more interference-mitigating code blocks is positioned within a same orthogonal frequency division multiplexing symbol.

17. The receiver of claim 14, wherein the processing system, to cause the receiver to decode the MIMO transmission, is configured to cause the receiver to:
decode a first interference-mitigating code block of the code block resources in parallel with performing successive interference cancellation using a second column of code block resources.

18. A method of wireless communication performed by a transmitter, comprising:
mapping two or more code blocks across N layers of a multiple-input, multiple-output (MIMO) transmission, each code block of the two or more code blocks being separated into N code block partitions such that each layer of the N layers is assigned a respective code block partition of the N code block partitions, the mapping of the two or more code blocks being based at least in part on a spatially-coupled MIMO-based mapping scheme and N being an integer greater than two;
mapping two or more interference-mitigating code blocks across the N layers of the MIMO transmission, each interference-mitigating code block being separated into N interference-mitigating code block partitions such that each layer of the N layers is assigned a respective interference-mitigating code block partition of the N code block partitions, the mapping of the two or more interference-mitigating code blocks being complementary to the mapping of the two or more code blocks; and
transmitting the MIMO transmission based at least in part on the mapping of the two or more code blocks and the mapping of the two or more interference-mitigating code blocks.

19. The method of claim 18, wherein N is a first integer and the N layers are organized into L layer groups, L being a second integer, and
wherein a quantity of the two or more interference-mitigating code blocks that are mapped across the N layers of the MIMO transmission is one less than L.

20. The method of claim 19, wherein the quantity of the two or more interference-mitigating code blocks is a first quantity, and
wherein a value of L for the L layer groups is based at least in part on at least one of:
a second quantity of layers per transport block, or
a maximum supported number of layers per layer group.

21. The method of claim 18, wherein each layer of the N layers is partitioned into a respective set of code block resources,
wherein a column of code block resources is, collectively, a same code block resource in each respective set of code block resources of each layer of the N layers, and
wherein the mapping of the two or more interference-mitigating code blocks across the N layers comprises:
mapping, for each interference-mitigating code block of the two or more interference-mitigating code blocks, the N interference-mitigating code block partitions across two columns of code block resources.

22. The method of claim 21, wherein a first interference-mitigating code block of the two or more interference-mitigating code blocks is mapped to a first column of code block resources and a second column of code blocks, wherein the first column of code block resources and the second column of code block resources are separated by a code block resource difference, and
wherein a second interference-mitigating code block of the two or more interference-mitigating code blocks is mapped to a third column of code block resources and a fourth column of code block resources, wherein the third column of code block resources and the fourth column of code block resources are separated by the code block resource difference.

23. The method of claim 22, wherein the code block resource difference is configured such that mapping the two or more interference-mitigating code blocks positions each interference-mitigating code block of the two or more interference-mitigating code blocks within a same orthogonal frequency division multiplexing symbol.

24. The method of claim 22, wherein N is a first integer and the N layers are organized into L layer groups, L being a second integer, and
wherein mapping, for each interference-mitigating code block of the two or more interference-mitigating code blocks, the N interference-mitigating code block partitions across the two columns of code block resources is based at least in part on the L layer groups.

25. The method of claim 18, wherein mapping the two or more code blocks across the N layers of the MIMO transmission, and mapping the two or more interference-mitigating code blocks across the N layers of the MIMO transmission, are collectively performed based at least in part on a first SC MIMO-based mapping scheme, and
wherein the method further comprises:
receiving a measurement metric that indicates to switch from the first SC MIMO-based mapping scheme to a second SC MIMO-based mapping scheme; and
switching from using the first SC MIMO-based mapping scheme to using the second SC MIMO-based mapping scheme.

26. A method of wireless communication performed by a receiver, comprising:
receiving a multiple-input, multiple-output (MIMO) transmission that includes N layers, N being an integer that is greater than two, the MIMO transmission including two or more code blocks and two or more interference-mitigating code blocks; and
decoding the MIMO transmission based at least in part on:
a first mapping of the two or more code blocks across the N layers of the MIMO transmission, each code block of the two or more code blocks being separated into N code block partitions such that each layer of the N layers includes a respective code block partition of the N code block partitions, the first mapping of the two or more code blocks being based at least in part on a spatially-coupled MIMO-based mapping scheme, and
a second mapping of the two or more interference-mitigating code blocks across the N layers of the MIMO transmission, each interference-mitigating code block being separated into N interference-mitigating code block partitions such that each layer of the N layers includes a respective interference-mitigating code block partition of the N code block partitions, the second mapping of the two or more interference-mitigating code blocks being complementary to the first mapping of the two or more code blocks.

27. The method of claim 26, wherein N is a first integer and the N layers are organized into L layer groups, L being a second integer, and
wherein a quantity of the two or more interference-mitigating code blocks that are mapped across the N layers of the MIMO transmission is one less than L.

28. The method of claim 26, wherein each layer of the N layers is partitioned into a respective set of code block resources,
wherein a column of code block resources is, collectively, a same code block resource in each respective set of code block resources of each layer of the N layers, and
wherein the second mapping of the two or more interference-mitigating code blocks across the N layers is based at least in part on, for each interference-mitigating code block of the two or more interference-mitigating code blocks, the N interference-mitigating code block partitions being mapped across two columns of code block resources.

29. The method of claim 28, wherein the second mapping of the two or more interference-mitigating code blocks is based at least in part on:
a first interference-mitigating code block of the two or more interference-mitigating code blocks being mapped to a first column of code block resources and a second column of code block resources, wherein the first column of code block resources and the second column of code block resources are separated by a code block resource difference, and
a second interference-mitigating code block of the two or more interference-mitigating code blocks being mapped to a third column of code block resources and a fourth column of code block resources, wherein the third column of code block resources and the fourth column of code block resources are separated by the code block resource difference.

30. The method of claim 28, wherein N is a first integer and the N layers are organized into L layer groups, L being a second integer, and
wherein the second mapping is based at least in part on, for each interference-mitigating code block of the two or more interference-mitigating code blocks, the N interference-mitigating code block partitions being mapped across the two columns of code block resources based at least in part on the L layer groups.
